(19) United States
(12) Patent Application Publication
(10) Pub. No.: US 2017/0166122 A1
(43) Pub. Date: Jun. 15, 2017

(54) WARNING SYSTEM AND METHOD

(71) Applicant: FUJITSU LIMITED, Kawasaki-shi (JP)

(72) Inventors: Toshiaki Ando, Yokohama (JP); Masami Mizutani, Kawasaki (JP); Yasuhiro AOKI, Kawasaki (JP)

(21) Appl. No.: 15/377,137

(22) Filed: Dec. 13, 2016

(30) Foreign Application Priority Data
Dec. 14, 2015 (JP) 2015-242859

(51) Int. Cl. B60Q 9/00; G06F 3/01; G06K 9/00; H04N 5/225; H04N 7/18

(52) U.S. Cl. CPC B60Q 9/00; H04N 5/2256; H04N 7/183; G06K 9/00818; G06K 9/00798; G06F 3/013

(57) ABSTRACT

A method includes acquiring sign information related to a road sign in an advancing direction of a vehicle based on position and orientation of the vehicle, determining an estimated time period needed for a driver of the vehicle to recognize a substance of the road sign based on the position and orientation of the vehicle, and a complexity of the road sign determined based on the sign information, determining a gazing time period during which the driver gazes at the road sign based on images picked up by an image sensor, and outputting a warning based on a comparison between the estimated time period and the gazing time period.

### CROSS-REFERENCE TO RELATED APPLICATION

This application is based upon and claims the benefit of priority of the prior Japanese Patent Application No. 2015-242859, filed on Dec. 14, 2015, the entire contents of which are incorporated herein by reference.

### FIELD

The present technology disclosed in the embodiment relates to a technology for deciding a visual confirmation state of a road sign.

### BACKGROUND

As one of technologies by which safe driving of a vehicle is supported, a technology is available in which a sight line of a driver of a vehicle is detected to decide whether or not the driver visually confirms a road sign and, if the driver does not visually confirm the road sign, then a warning of this is provided to the driver. In a technology of the type just described, it is decided that, if the direction of the sight line of the driver coincides with a direction in which a road sign exists for equal to or more than a given time period, that the driver visually confirms the road sign.

In regard to the decision method described above, a method is known in which a degree of recognition of a road sign by a driver is decided on the basis of whether or not there is a road sign within a center view area centered at a direction of the sight line of the driver (for example, refer to Japanese Laid-open Patent Publication No. 2005-182307).

Further, as a calculation method for a direction of a road sign in the technology of the type described, a method is known in which a direction of a road sign is calculated on the basis of position information of a vehicle acquired utilizing the global positioning system (GPS) and information of installation positions of road signs prepared in advance (for example, refer to Japanese Laid-open Patent Publication No. 2001-034887).

### SUMMARY

According to an aspect of the embodiment, a method includes acquiring sign information related to a road sign in an advancing direction of a vehicle based on position and orientation of the vehicle, determining an estimated time period needed for a driver of the vehicle to recognize a substance of the road sign based on the position and orientation of the vehicle, and a complexity of the road sign determined based on the sign information, determining a gazing time period during which the driver gazes at the road sign based on images picked up by an image sensor, and outputting a warning based on a comparison between the estimated time period and the gazing time period.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram depicting a functional configuration of a road sign visual confirmation decision system according to a first embodiment;

FIG. 2 is a view depicting an example of installation of the road sign visual confirmation decision system according to the first embodiment;

FIG. 3 is a view depicting substance of road sign information;

FIG. 4 is a view illustrating a setting method of the number of routes;

FIG. 5 is a view illustrating a setting method of the number of graphic shape vectors;

FIG. 6 is a view illustrating substance of vehicle state information;

FIG. 7 is a view illustrating substance of gazing time period information;

FIG. 8 is a flow chart illustrating a visual confirmation decision process of a road sign;

FIG. 9A is a flow chart (part 1) illustrating substance of a gazing decision process;

FIG. 9B is a flow chart (part 2) illustrating the substance of the gazing decision process;

FIG. 9C is a flow chart (part 3) illustrating the substance of the gazing decision process;

FIG. 10 is a view illustrating a searching method for a road sign;

FIG. 11A is a view (part 1) illustrating a decision method of an overlap between a direction of a road sign and a sight line of a driver;

FIG. 11B is a view (part 2) illustrating the decision method of the overlap between the direction of the road sign and the sight line of the driver;

FIG. 11C is a view (part 3) illustrating the decision method of the overlap between the direction of the road sign and the sight line of the driver;

FIGS. 12A to 12C are views illustrating an example of calculation of a visual confirmation degree and a visual confirmation completion time period;

FIG. 13 is a block diagram depicting a functional configuration of a road sign visual confirmation decision system according to a second embodiment;

FIG. 14 is a view depicting an example of provision of the road sign visual confirmation decision system according to the second embodiment;

FIG. 15 is a block diagram depicting a functional configuration of a road sign visual confirmation decision system according to a third embodiment;

FIG. 16 is a block diagram depicting a functional configuration of a road sign visual confirmation decision system according to a fourth embodiment;

FIG. 17 is a block diagram depicting a functional configuration of a road sign visual confirmation decision system according to a fifth embodiment;

FIG. 18 is a block diagram depicting a functional configuration of a road sign visual confirmation decision system according to a sixth embodiment; and

FIG. 19 is a block diagram depicting a hardware configuration of a computer.

### DESCRIPTION OF EMBODIMENTS

Various road signs are installed on a road on which a vehicle can travel, and patterns and characters of such road signs differ in complexity depending upon substance of information to be conveyed to drivers. Therefore, while a road sign exists whose substance can be recognized immediately by a driver, also a road sign exists with regard to which the time period taken for recognition of the substance by the driver is longer than that of some other road sign. Accordingly, there is the possibility that, if it is decided utilizing a fixed criterion irrespective of the substance of a road sign whether or not a driver recognizes the substance of a road sign, then an erroneous decision may be performed.

In a first aspect, the technology disclosed through the embodiment reduces erroneous decisions when it is decided whether or not a driver recognizes the substance of a road sign on the basis the sight line of the driver.

### First Embodiment

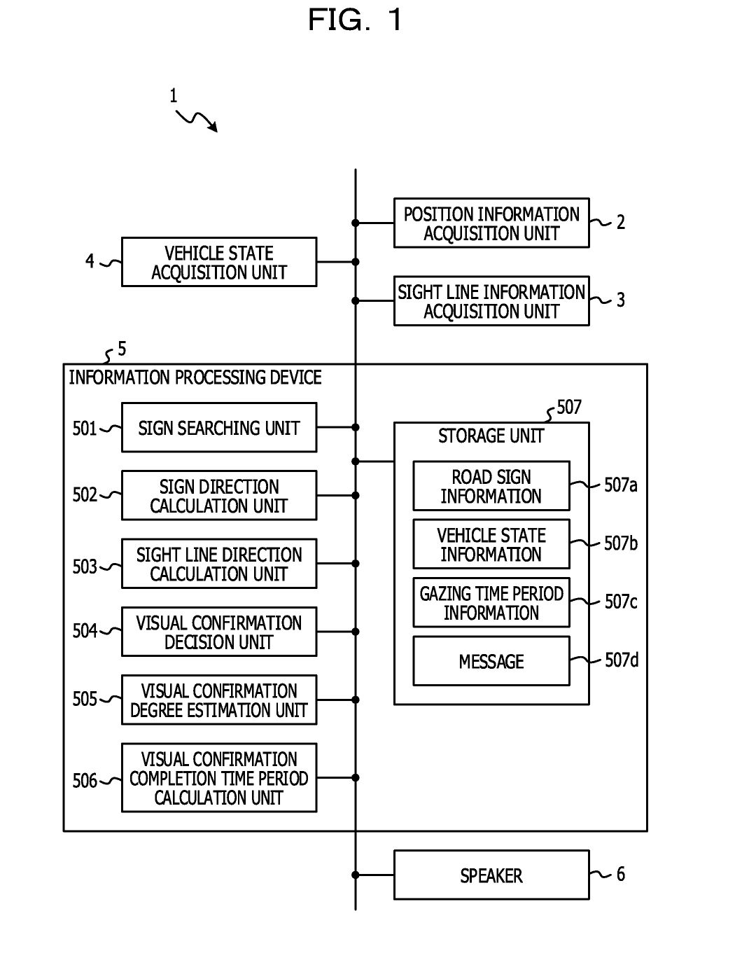

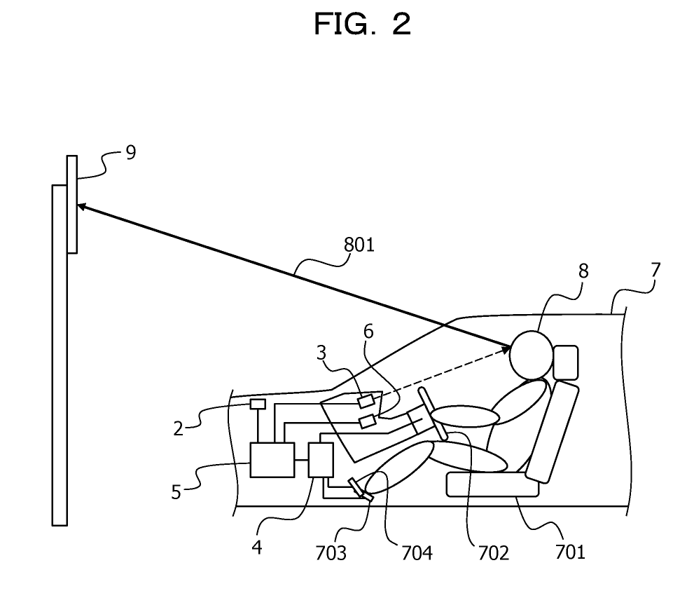

FIG. 1 is a block diagram depicting a functional configuration of a road sign visual confirmation decision system according to a first embodiment. FIG. 2 is a view depicting an example of installation of the road sign visual confirmation decision system according to the first embodiment.

As depicted in FIG. 1, a road sign visual confirmation decision system 1 according to the present embodiment includes a position information acquisition unit 2, a sight line information acquisition unit 3, a vehicle state acquisition unit 4, an information processing device 5 and a speaker 6. For example, as depicted in FIG. 2, the road sign visual confirmation decision system 1 is used for decision of whether or not a driver 8 of a vehicle 7 visually confirms a road sign 9 provided on a road. Here, whether or not the driver 8 visually confirms the road sign 9 signifies not whether or not the driver 8 simply recognizes presence of the road sign 9 but whether or not the driver 8 recognizes the substance of information the road sign 9 has. In the following description, the road sign visual confirmation decision system 1 is sometimes referred to simply as visual confirmation decision system 1.

The position information acquisition unit 2 acquires position information of the vehicle 7 including a position and an orientation of the vehicle 7. A GPS receiver can be utilized for the position information acquisition unit 2.

The sight line information acquisition unit 3 acquires information to be used for calculating a direction of a sight line 801 of the driver 8 of the vehicle 7 (sight line information). A set of an infrared light emitting diode (LED) and an infrared camera can be utilized for the sight line information acquisition unit 3. Where the set of an infrared light emitting diode and an infrared camera is used for the sight line information acquisition unit 3, the infrared light emitting diode is provided in such an orientation that outputted infrared ray is irradiated on the face of the driver 8. Further, the infrared camera is provided in such an orientation that an image including the eyeballs of the driver 8 is picked up. In other words, the sight line information acquisition unit 3 including the infrared light emitting diode and the infrared camera acquires, as sight line information, image including the eyeballs of the driver 8 on which infrared ray is irradiated.

The vehicle state acquisition unit 4 acquires a state (vehicle state) at present of the vehicle 7 including the speed at present of the vehicle 7 and the position of a driver's seat 701. The vehicle state acquisition unit 4 acquires, in addition to the speed at present of the vehicle 7 and the position of the driver's seat 701, for example, a steering angle of a steering member (steering wheel) 702, an operation amount of an acceleration pedal 703 and an operation amount of a brake pedal 704 and so forth. The vehicle state acquisition unit 4 acquires the speed of the vehicle 7, the steering angle of the steering member 702 and so forth at given time intervals (for example, every 0.5 seconds). For the vehicle state acquisition unit 4, various electronic controlling units (ECUs), for example, incorporated in the vehicle 7 can be utilized.

The information processing device 5 decides whether or not the driver 8 recognizes the substance of a road sign 9 on the basis of position information and a vehicle state of the vehicle 7, a direction of the sight line 801 of the driver 8 and information of a road sign 9 located in front of the vehicle 7. The information processing device 5 in the present embodiment estimates a visual confirmation degree regarding the road sign 9 using the information regarding the road sign 9 and estimates a time period (visual confirmation completion time period) taken for recognition of the substance of the road sign 9 by the driver 8 using the estimated visual confirmation degree and the position information and the vehicle state of the vehicle 7. The visual confirmation degree regarding the road sign 9 is a parameter representing a degree of ease in recognition of the substance of the road sign 9, and is estimated on the basis of a degree of complexity of the substance described on a sign indicating face (hereinafter referred to simply sometimes as “indication face”). The information processing device 5 calculates a time period (gazing time period) for which the driver 8 gazes the road sign 9 in a direction of the sight line 801 of the driver 8 and decides that the driver 8 recognizes the substance of the road sign 9 if the gazing time period exceeds the visual confirmation completion time period.

Further, the information processing device 5 in the present embodiment generates a voice signal including a message for the driver 8 when the direction of the sight line 801 of the driver 8 moves to a direction different from the direction of the road sign 9 before the gazing time period elapses the visual confirmation completion time period. The voice signal (message) generated by the information processing device 5 is outputted from the speaker 6.

The information processing device 5 in the present embodiment includes a sign searching unit 501, a sign direction calculation unit 502, a sight line direction calculation unit 503, a visual confirmation decision unit 504, a visual confirmation degree estimation unit 505, a visual confirmation completion time period calculation unit 506 and a storage unit 507.

The sign searching unit 501 searches for a road sign 9 installed toward the driver 8 of the vehicle 7 in front of the vehicle 7 using the position information of the vehicle 7 acquired by the position information acquisition unit 2 and road sign information 507a of the storage unit 507. The road sign information 507a includes a type of the sign, an installation position and an orientation of the indication face of the road sign installed on the road.

The sign direction calculation unit 502 calculates a direction of the road sign 9 as viewed from the driver 8 of the vehicle 7. The sign direction calculation unit 502 calculates a direction of the road sign 9 as viewed from the driver 8 seated on the driver's seat 701, for example, using the position information of the vehicle 7, a position of the driver's seat 701 of the vehicle 7 and the road sign information 507a of the storage unit 507.

The sight line direction calculation unit 503 calculates a direction of the sight line 801 of the driver 8 using the sight line information acquired by the sight line information acquisition unit 3. If an image including the eyeballs of the driver 8 on which an infrared ray is irradiated is acquired as the sight line information, then the sight line direction calculation unit 503 calculates the direction of the sight line 801 of the driver 8 by a pupillary-corneal reflex method.

The visual confirmation decision unit 504 decides whether or not the driver 8 recognizes the substance of the road sign 9. The visual confirmation decision unit 504 calculates a gazing time period for which the driver 8 gazes the road sign 9 using the direction of the road sign 9 calculated by the sign direction calculation unit 502 and the direction of the sight line 801 of the driver 8 calculated by the sight line direction calculation unit 503. Further, the visual confirmation decision unit 504 causes the visual confirmation degree estimation unit 505 to estimate a visual confirmation degree of the road sign 9 and causes the visual confirmation completion time period calculation unit 506 to calculate an estimation value of the visual confirmation completion time period of the road sign 9. Further, the visual confirmation decision unit 504 decides whether or not the driver 8 recognizes the substance of the road sign 9 on the basis of a relationship between the calculated gazing time period and the estimation value of the visual confirmation completion time period.

The visual confirmation degree estimation unit 505 estimates a visual confirmation degree of the road sign 9 on the basis of the information regarding the road sign 9. The visual confirmation degree estimation unit 505 estimates a visual confirmation degree of the road sign 9 on the basis of the number of characters and the degree of complexity of a graphic shape described on the indication face of the road sign 9.

The visual confirmation completion time period calculation unit 506 calculates an estimation value of a time period (visual confirmation completion time period) taken for recognition of the substance of the road sign 9 by the driver 8 of the vehicle 7. The visual confirmation completion time period calculation unit 506 calculates an estimation value of the visual confirmation completion time period on the basis of the visual confirmation degree estimated by the visual confirmation degree estimation unit 505, the distance from the driver 8 of the vehicle 7 to the road sign 9 and the speed of the vehicle 7. The estimation value of the visual confirmation completion time period is hereinafter referred to simply as visual confirmation completion time period.

Into the storage unit 507, various kinds of information including the road sign information 507a, vehicle state information 507b, gazing time period information 507c and a message 507d is stored.

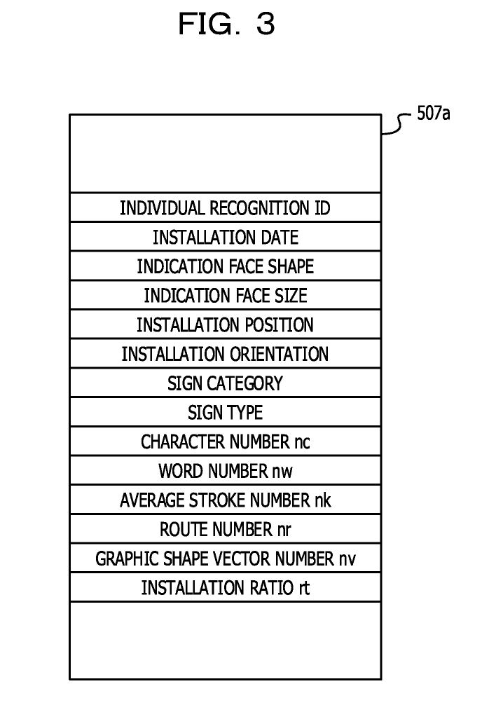

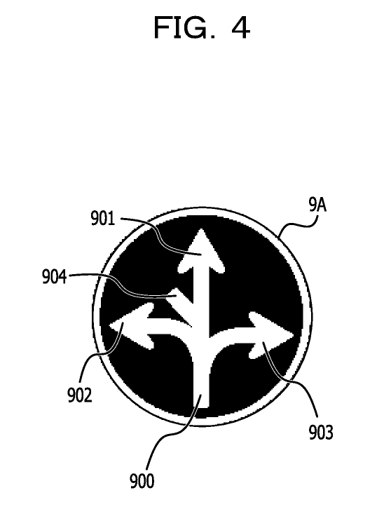

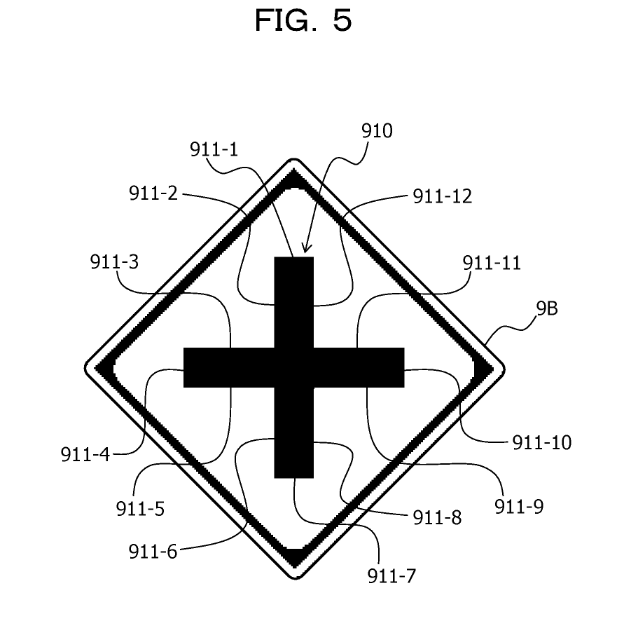

FIG. 3 is a view depicting substance of road sign information. FIG. 4 is a view illustrating a setting method of the number of routes. FIG. 5 is a view illustrating a setting method of the number of graphic shape vectors.

In the road sign information 507a, information about each of a great number of road signs installed on roads within a given region (for example, in Japan) including a region in which the vehicle 7 travels is registered. As illustrated in FIG. 3, information regarding one road sign in the road sign information 507a includes information representing an individual recognition identification (ID), an installation date, indication face shape, an indication face size, an installation position and an installation orientation. The information regarding one road sign further includes information representing a sign category, a sign type, the number nc of characters, the number nw of words, an average number nk of strokes, the number nr of routes, the number nv of graphic shape vectors and an installation ratio rt.

The individual recognition ID is an identifier such as a number given to each road sign in order to identify the road sign. The installation date represents the date (year, month and day) at which the road sign is installed. The indication face shape is information representing a shape of the sign indication face of the road sign, and information such as a circular shape, a rectangular shape, a diamond shape or the like is described. The indication face size represents a size of the sign indication face. The installation position is information representing an installation position of the road sign, and coordinates of the center of the indication face in a coordinate system with reference to the ground surface determined by the GPS or the like are described in the installation position. The installation orientation is information representing an orientation of the indication face and is described by an angle of a normal direction to the indication face in a horizontal plane where the north direction is defined as 0 degrees.

The sign category is information representing a category of the sign, and information representing which one of a danger warning sign, a regulatory sign, an instruction sign and a guide sign the road sign is described in the sign category. The sign type is information representing into what type in the categorized sign the road sign falls. Where the sign category is the danger warning sign, for example, such information a “there is a crossing,” “there is a right (or left) turn” or the like is described in the sign type. Further, where the sign category is a regulatory sign, for example, information of a value of the highest speed, “temporary stop” or the like is described in the sign type.

The character number nc represents a total number of characters in the sign or the number of characters described in a given language. The word number nw represents a total number of words in the sign or the number of words described in a given language. The average stroke number nk is an average number of strokes of characters counted by the character number nc.

The route number nr represents the number of routes (directions) along which advancement is performed in a regulatory sign or a guide sign. For example, in a road sign 9A representing “inhibition of advancement except specified direction(s)” depicted in FIG. 4, an arrow mark branching in three directions indicated by an arrowhead portion 901 at an upper portion of the indication face from a single root portion 900 positioned at a lower portion of the indication face, another arrowhead portion 902 at the left portion of the indication face and a further arrowhead portion 903 at the right portion of the indication face is described. Further, on the road sign 9A, a branching portion 904 extending leftwardly upwardly from the branching point of the arrow mark directed upwardly on the indication face and another arrow mark curved leftwardly on the indication face is described. Therefore, the route number nr on the road sign 9A depicted in FIG. 4 is four.

The graphic shape vector number nv represents the number of elements when a shape of a graphic pattern described on the indication face is represented by a vector form. For example, where a graphic pattern of a cross mark 910 at the center of a road sign 9B that represents “there is a cross-shaped crossing” depicted in FIG. 5 is represented by a vector form, the graphic pattern is represented by a combination of a side extending in a horizontal direction and a side extending in a perpendicular direction that configure a contour. The contour of the cross mark 910 is configured from twelve edges 911-m (m is an integer from 1 to 12) as viewed in the counterclockwise direction from the edge 911-1 positioned at an upper end portion and extending in the horizontal direction. Therefore, the graphic shape vector number nv of the road sign 9B depicted in FIG. 5 is 12.

The installation ratio rt represents, for example, an installation ratio for each sign type in a region in which road signs that are a registration target into the road sign information 507a are installed.

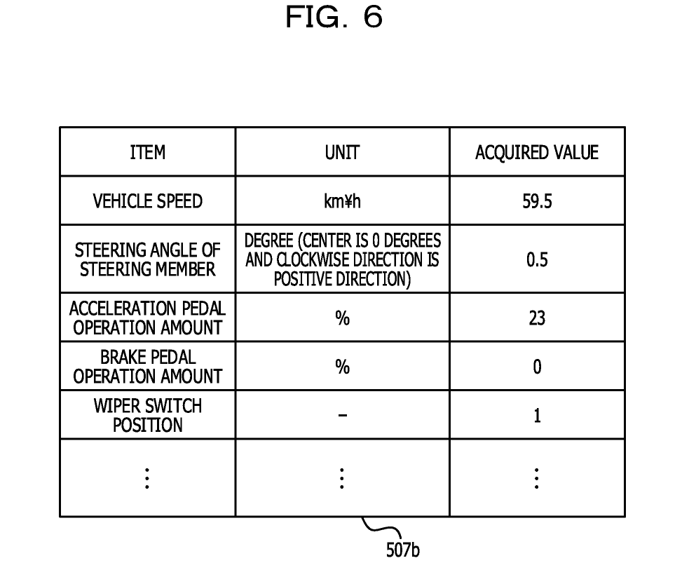

FIG. 6 is a view illustrating substance of vehicle state information. As illustrated in FIG. 6, the vehicle state information 507b includes a vehicle speed, a steering angle of the steering member, an operation amount of the acceleration pedal, an operation amount of the brake pedal and a wiper switch position.

The vehicle speed represents a speed at present of the vehicle 7 (unit is km/hour). The steering angle of the steering member represents an operation angle of the steering member (steering wheel), and the steering angle when the vehicle 7 advances straightly is 0 degrees (center) and the clockwise direction as viewed from the driver is determined as a positive direction of the steering angle. The operation amount of the acceleration pedal and the operation amount of the brake pedal are each represented by a value in the form of a percentage where it is represented by 0 when the driver 8 does not operate the pedal and by 100 when the driver 8 operates the pedal to its maximum operation amount. The wiper switch position is represented by a value representative of a position of the switch for changing over operation of the wiper. Where the operation of the wiper is performed among three stages of intermittent, low speed and high speed operations, for example, the switch position for switching off of the operation is “0” and the positions of the switch when the wiper is operated intermittently, at a low speed and at a high speed are “1,” “2” and “3,” respectively.

The various kinds of information in the vehicle state information 507b are updated every given interval of time (for example, every 0.5 seconds) by the vehicle state acquisition unit 4.

It is to be noted that, though not depicted in FIG. 6, the vehicle state information 507b has, for example, as information representative of the position of the driver's seat 701, the height from the road surface to the head rest of the driver's seat 701, the position of the head rest of the driver's seat in the vehicle body or the like. The information representative of the position of the driver's seat 701 may be a fixed value or a variable value that varies, for example, in response to the amount of movement every time the driver 8 moves the position of the driver's seat 701.

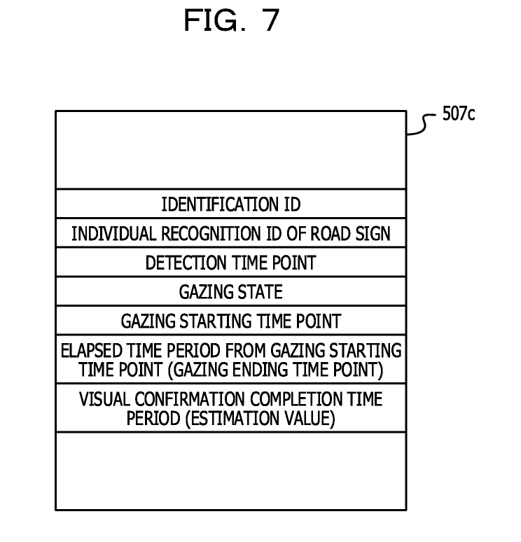

FIG. 7 is a view illustrating substance of gazing time period information. The gazing time period information 507c is information to be used for decision of whether or not the substance of the road sign 9 detected by the sign searching unit 501 is recognized by the driver 8. As depicted in FIG. 7, the information of one road sign in the gazing time period information 507c includes an identification ID, an individual recognition ID of the road sign, a detection time point, a gazing state, a gazing starting time point, an elapsed time period from the gazing starting time point, and an estimation value of the visual confirmation completion time period.

The identification ID is an identifier such as a number for identifying a plurality of road signs detected by the sign searching unit 501 during traveling of the vehicle 7. The individual recognition ID of a road sign is information for specifying the detected road sign and includes the individual recognition ID of the road sign information 507a. The detection time point is a point of time at which the road sign is detected by the sign searching unit 501.

The gazing state is information representative of a gazing state of the detected road sign by the driver. The gazing state of the driver includes three states of “state in which the driver does not see as yet,” “continuing (state in which the driver is visually confirming” and “completion (state in which the visual confirmation ends).”

The gazing starting time point is a point of time at which the visual confirmation decision unit 504 decides that the driver 8 looks at a road sign 9 first, or in other words, a point of time at which the gazing state changes from the “state in which the driver does not see as yet” to the “state in which the driver is gazing.” The elapsed time period from the gazing starting time point is a gazing time period of a road sign 9 by the driver 8, or in other words, is a period of time within which the decision by the visual confirmation decision unit 504 that the road sign 9 is being gazed by the driver 8 continues after the gazing starting time point. The time counting of the elapsed time period from the gazing starting time point ends at a point of time at which the gazing state changes from the “state in which the driver is gazing” to the “state in which the gazing state ends.”

The estimation value of the visual confirmation completion time period is a visual confirmation completion time period calculated by the visual confirmation completion time period calculation unit 506.

The gazing time period information 507c may be accumulations of information of all detected road signs or accumulations of information only of road signs decided by the visual confirmation decision unit 504 as being recognized by the driver (or road signs decided not to be recognized by the driver).

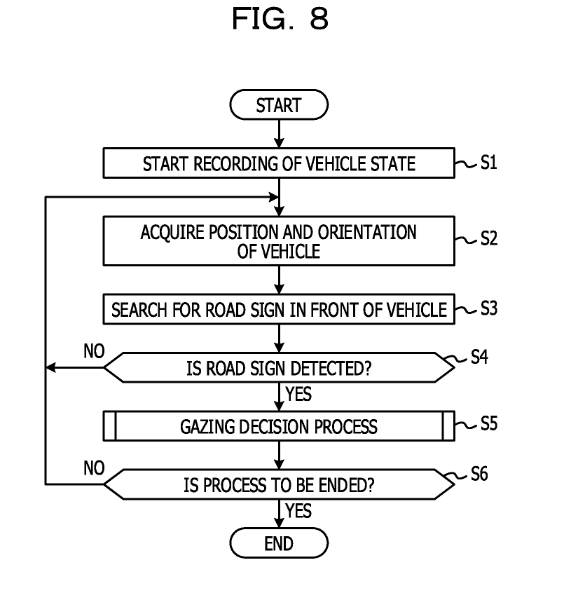

FIG. 8 is a flow chart illustrating a visual recognition decision process of a road sign.

In the visual confirmation decision system 1 of the present embodiment, recording of a vehicle state is started as illustrated in FIG. 8 (step S1). The process at step S1 is performed by the vehicle state acquisition unit 4. The vehicle state acquisition unit 4 periodically acquires various kinds of information representative of a state of the vehicle 7 (vehicle state information) including a speed, a steering angle of the steering member, an operation amount of the brake pedal, an operation amount of the acceleration pedal, the position of the wiper switch and the position of the driver's seat of the vehicle 7. The vehicle state acquisition unit 4 stores the acquired vehicle state information into the storage unit 507 of the information processing device 5. Thereupon, the vehicle state information 507b of the storage unit 507 may retain only the latest vehicle state information or may otherwise accumulate the vehicle state information for a given period of time.

Then, the visual confirmation decision system 1 acquires the position and the orientation of the vehicle (step S2). The process at step S2 is performed by the position information acquisition unit 2. Where a GPS receiver is used as the position information acquisition unit 2, the position information acquisition unit 2 receives signals from GPS satellites to acquire the current position of the vehicle on a coordinate system of the ground. Further, the position information acquisition unit 2 acquires the orientation of the vehicle 7 at present on the basis of the last-minute position of the vehicle 7 and the position of the vehicle 7 at present. The position information acquisition unit 2 transmits the acquired information of the position and the orientation of the vehicle 7 at present to the sign searching unit 501 of the information processing device 5.

Then, the visual confirmation decision system 1 searches for a road sign in front of the vehicle (step S3) and decides whether or not there exists a road sign forwardly (step S4). The processes at steps S3 and S4 are performed by the sign searching unit 501. The sign searching unit 501 uses the position and the orientation of the vehicle 7 and the road sign information 507a to perform a search to decide whether or not a road sign 9 that presents information to the driver 8 of the vehicle 7 is placed within a given range in front of the vehicle (in the advancing direction of the vehicle). If a road sign 9 is not placed within the given range in front of the vehicle (step S4: No), then the processing to be performed by the visual confirmation decision system 1 returns to step S2.

On the other hand, if a road sign or signs 9 are placed within the given range in front of the vehicle (step S4: Yes), then the visual confirmation decision system 1 subsequently performs a gazing decision process (step S5). The process at step S5 is performed by the sign direction calculation unit 502, sight line direction calculation unit 503, visual confirmation decision unit 504, visual confirmation degree estimation unit 505 and visual confirmation completion time period calculation unit 506. At step S5, a period within which the direction of the sight line 801 of the driver 8 calculated by the sight line direction calculation unit 503 coincides with the direction of the road sign 9 calculated by the sign direction calculation unit 502 is calculated, and this period is determined as a period (gazing period) within which the driver 8 remains gazing the road sign 9. Further, at step S5, after a visual confirmation degree of the road sign 9 is estimated on the basis of the road sign information 507a, an estimation value of the visual confirmation completion time period is calculated on the basis of the visual confirmation degree and the vehicle state information 507b. Further, at step S5, it is decided on the basis of the gazing period and the estimation value of the visual confirmation completion time period whether or not the driver 8 recognizes the substance of the road sign 9.

After the gazing decision process at step S5, the visual confirmation decision system 1 decides whether or not the visual confirmation decision process is to be ended (step S6). If the engine of the vehicle 7 stops, if the driver 8 performs an operation for ending the processing or in a like case, the visual confirmation decision system 1 ends the visual confirmation decision process (step S6: Yes). On the other hand, the visual confirmation decision process is not to be ended (step S6: No), then the processing to be performed by the visual confirmation decision system 1 returns to step S2.

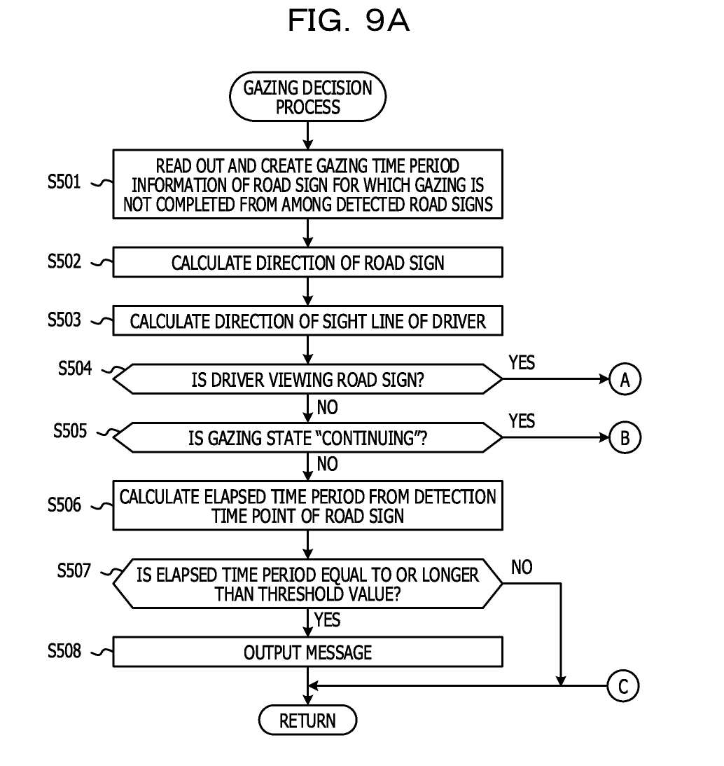

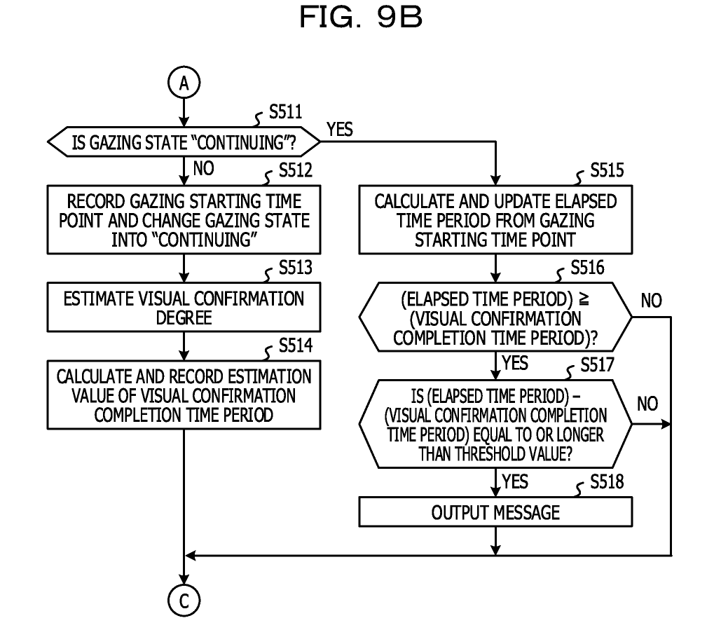

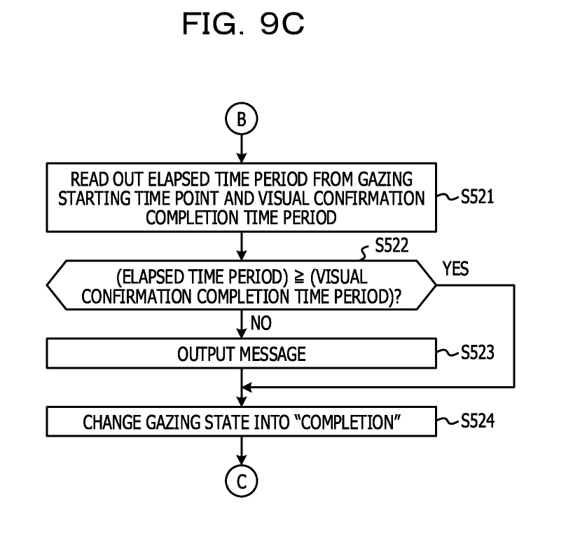

FIG. 9A is a flow chart (part 1) illustrating substance of a gazing decision process. FIG. 9B is a flow chart (part 2) illustrating the substance of the gazing decision process. FIG. 9C is a flow chart (part 3) illustrating the substance of the gazing decision process.

In the gazing decision process (step S5), the visual confirmation decision system 1 first performs reading out and creation of gazing time period information of the road sign 9 for which gazing is not completed from among the detected road signs 9 (step S501). The process at step S501 is performed, for example, by the visual confirmation decision unit 504. The visual confirmation decision unit 504 searches the gazing time period information 507c using an individual recognition ID of the road sign 9 detected by the sign searching unit 501 as a key to read out the gazing time period information of the detected road sign 9. Further, if the gazing time period information regarding the detected road sign 9 is not stored in the storage unit 507, then the visual confirmation decision unit 504 adds the gazing time period information of the newly detected road sign 9 to the storage unit 507. When the gazing time period information is added, the visual confirmation decision unit 504 inputs the identification ID of the detected road sign in FIG. 7, individual recognition ID of the road sign and detection time point and sets the gazing state to a value representative of a state in which the road sign is not viewed as yet (for example, to “0”).

Then, the visual confirmation decision system 1 calculates the direction of the road sign 9 (step S502) and calculates the direction of the sight line of the driver 8 (step S503). The process at step S502 is performed by the sign direction calculation unit 502. The sign direction calculation unit 502 calculates the direction of the road sign 9 as viewed from the driver 8 on the basis of the information of the position and the orientation of the vehicle 7, the position of the driver's seat and the information of the installation position of the road sign 9. The sign direction calculation unit 502 transmits the calculated direction of the road sign 9 to the visual confirmation decision unit 504. Meanwhile, the process at step S503 is performed by the sight line direction calculation unit 503. The sight line direction calculation unit 503 calculates the direction of the sight line of the driver 8 on the basis of a positional relationship of the positions of corneal reflection and the center positions of the pupils of the eyeballs of the driver 8 included in the image acquired from the sight line information acquisition unit 3. The sight line direction calculation unit 503 transmits the calculated direction of the sight line of the driver to the visual confirmation decision unit 504.

Then, the visual confirmation decision system 1 decides whether or not the driver 8 is viewing the road sign 9 (step S504). The decision at step S504 is performed by the visual confirmation decision unit 504. The visual confirmation decision unit 504 compares the direction of the road sign 9 calculated by the sign direction calculation unit 502 and the direction of the sight line of the driver 8 calculated by the sight line direction calculation unit 503 with each other and decides, if the displacement between the directions is equal to or smaller than a given angle threshold value, that the driver 8 is viewing the road sign 9. If it is decided that the driver 8 is viewing the road sign 9 (step S504: Yes), then the visual confirmation decision system 1 performs the process illustrated in FIG. 9B.

If it is decided that the driver 8 is not viewing the road sign 9 (step S504: No), then the visual confirmation decision system 1 subsequently decides whether or not the gazing state of the gazing time period information has a value representing “continuing” (step S505). The decision at step S505 is performed by the visual confirmation decision unit 504. The visual confirmation decision unit 504 checks whether or not the gazing state in the gazing time period information read out and the gazing time period information created at step S501 has the value indicative of “continuing” (for example, “1”). If the gazing state has the value indicative of “continuing” (step S505: Yes), then the visual confirmation decision system 1 performs a process illustrated in FIG. 9C.

If the gazing state does not have the value indicative of “continuing” (step S505: No), then the visual confirmation decision system 1 subsequently calculates an elapsed time period from the detection time point of the road sign 9 (step S506) and then decides whether or not the calculated elapsed time period is equal to or longer than a threshold value (step S507). The processes at steps S506 and S507 are performed by the visual confirmation decision unit 504. At step S506, the visual confirmation decision unit 504 calculates, as the elapsed time period from the detection time point of the road sign 9, for example, the difference between the time at present and the detection time point of the gazing time period information. If the elapsed time period from the detection time point of the road sign 9 is equal to or longer than the threshold value, then the possibility that the driver 8 may not notice the road sign 9 is high. Therefore, if the elapsed time period from the detection time point of the road sign 9 is equal to or longer than the threshold value (step S507: Yes), then the visual confirmation decision system 1 outputs a message for notifying the driver 8 that a road sign 9 exists forwardly (in the advancing direction) (step S508), whereafter the visual confirmation decision system 1 ends the gazing decision process. The process at step S508 is performed by the visual confirmation decision unit 504. The visual confirmation decision unit 504 reads out a voice signal of the message for the notification that there exists a road sign 9 in front of the vehicle from the message 507d of the storage unit 507 and transmits the voice signal to the speaker 6.

On the other hand, if the elapsed time period from the detection time point of the road sign 9 is shorter than the threshold value (step S507; No), then the visual confirmation decision system 1 ends the gazing decision process without performing the process at step S508.

When the sign searching unit 501 searches for a road sign 9, it may be advisable to determine, for example, the distance of 100 m from the vehicle 7 in front of the vehicle 7 as a search range. In this case, the possibility that the sign searching unit 501 may detect a road sign 9 before the driver 8 visually finds out the road sign 9 is high. In other words, the possibility that, at the point of time at which the sign searching unit 501 detects the road sign 9, the driver 8 may not take notice of the road sign 9 as yet is high. Therefore, in the gazing decision process in the present embodiment, a message is outputted when the elapsed time period after the road sign 9 is detected becomes equal to or longer than the threshold value. Consequently, the outputting frequency of the message in a state in which the driver 8 does not take notice of the detected road sign 9 as yet can be suppressed. Therefore, it is possible to minimize an oversight or the like by the driver 8 while the burden on the driver 8 when the driver 8 visually searches for the road sign 9 is reduced.

Now, processes performed by the visual confirmation decision system 1 when it is decided at step S504 that the driver 8 is viewing the road sign 9 are described with reference to FIG. 9B.

If it is decided at step S504 that the driver 8 is viewing the road sign 9, then two cases are available including a case in which, in the last gazing decision process, the driver did not view the road sign as yet and another case in which the driver continues to view the road sign from the point of time of the last or preceding gazing decision process. Therefore, when it is decided at step S504 that the driver 8 is viewing the road sign 9 (step S504: Yes), the visual confirmation decision system 1 subsequently decides whether or not the gazing state of the gazing time period information has the value indicative of “continuing” as illustrated in FIG. 9B (step S511). The decision at step S511 is performed by the visual confirmation decision unit 504. The visual confirmation decision unit 504 checks whether or not the gazing state in the gazing time period information read out and the gazing time period information created at step S501 has the value indicative of “continuing.” If the decision at step S511 is that the gazing state has the value indicative of “continuing,” then this represents that the driver 8 continues to view the road sign 9 from the point of time of the last or preceding gazing decision process. In other words, if the gazing state in the decision at step S511 does not have the value indicative of “continuing,” then this represents that the driver 8 views the road sign 9 for the first time at the timing at which the gazing decision process is performed in the present cycle. Accordingly, when the gazing state does not have the value indicative of “continuing” (step S511: No), the visual confirmation decision system 1 subsequently records the gazing starting time point and changes the gazing state to the value indicative of “continuing” (step S512).

After step S512, the visual confirmation decision system 1 estimates a visual confirmation degree (step S513). The process at step S513 is performed by the visual confirmation degree estimation unit 505. The visual confirmation degree estimation unit 505 calculates an estimation value of the visual confirmation degree of the road sign 9 using the road sign information 507a. The visual confirmation degree estimation unit 505 calculates an estimation value of the visual confirmation degree using such an expression that, for example, as the complexity of the road sign calculated on the basis of a character number nc, a graphic shape vector number nv and so forth of road sign information increases, the visual confirmation degree decreases.

After an estimation value of the visual confirmation degree is calculated, the visual confirmation decision system 1 calculates an estimation value of the visual confirmation completion time period and records the calculated estimation value into the gazing time period information (step S514). The process at step S514 is performed by the visual confirmation completion time period calculation unit 506. The visual confirmation completion time period calculation unit 506 calculates an estimation value of the period of time (visual confirmation completion time period) taken for the driver 8 to recognize the substance of the road sign 9 on the basis of the estimation value of the visual confirmation degree calculated by the visual confirmation degree estimation unit 505, the distance from the driver 8 to the road sign 9 and the speed of the vehicle 7. After the visual confirmation completion time period calculation unit 506 records the estimation value of the visual confirmation completion time period into the gazing time period information, the visual confirmation decision system 1 ends the gazing decision process. The estimation value of the visual confirmation completion time period is hereinafter referred to also as visual confirmation completion time period simply.

On the other hand, if the gazing state in the decision at step S511 has the value indicative of “continuing,” then this signifies that the driver 8 continues to gaze the road sign 9 from the point of time of the last or preceding gazing decision process as described hereinabove. Accordingly, when the gazing state has the value indicative of “continuing” (step S511: Yes), then the visual confirmation decision system 1 calculates and updates the elapsed time period from the gazing starting time point (step S515). The process at step S515 is performed by the visual confirmation decision unit 504. In the process at step S515, the visual confirmation decision unit 504 calculates, for example, the difference between the time at present and the gazing starting time point of the gazing time period information and updates the elapsed time period from the gazing starting time point of the gazing time period information with the difference.

After the process at step S515, the visual confirmation decision system 1 decides whether or not the calculated elapsed time period is equal to or longer than the visual confirmation completion time period (step S516). The decision at step S516 is performed by the visual confirmation decision unit 504. At the point of time at which the decision at step S516 is performed, the driver 8 still continues to gaze the road sign 9, and therefore, if the calculated elapsed time period does not reach the visual confirmation completion time period, then it is difficult to decide whether or not the driver 8 recognizes the substance of the road sign 9. Therefore, when the calculated elapsed time period is shorter than the visual confirmation completion time period (step S516: No), the visual confirmation decision system 1 ends the gazing decision process without performing the processes at steps S517 and S518.

If the calculated elapsed time period is equal to or longer than the visual confirmation completion time period (step S516), then the visual confirmation decision system 1 subsequently decides whether or not the value of the difference between the calculated elapsed time period and the visual confirmation completion time period is equal to or higher than a threshold value (step S517). If the value when the visual confirmation completion time period is subtracted from the calculated elapsed time period is a positive value, then this signifies that the driver 8 continues to view the road sign 9 also after the time taken for visual confirmation of the road sign 9. Therefore, if the value when the visual confirmation completion time period is subtracted from the calculated elapsed time period is equal to or longer than the threshold value (step S517: Yes), then the visual confirmation decision system 1 outputs, for example, a message for urging the driver 8 to move its sight line (step S518) and then ends the gazing decision process. The process at step S518 is performed, for example, by the visual confirmation decision unit 504. The visual confirmation decision unit 504 reads out a voice signal of the message for urging the driver 8 to move its sight line from the message 507d of the storage unit 507 and transmits the voice signal to the speaker 6.

Now, processing to be performed by the visual confirmation decision system 1 when the gazing state has the value indicative of “continuing” at step S505 is described with reference to FIG. 9C.

If it is decided at step S505 that the gazing state has the value indicative of “continuing,” then this indicates that, although the driver 8 was viewing the road sign 9 at the point of time of the last gazing decision process, the driver 8 is not viewing the road sign 9 in the gazing decision process of the present cycle. Therefore, when it is decided at step S505 that the gazing state has the value representative of “continuing” (step S505: Yes), then the visual confirmation decision system 1 subsequently reads out the elapsed time period from the gazing starting time point and the visual confirmation completion time period as depicted in FIG. 9C (step S521). The process at step S521 is performed by the visual confirmation decision unit 504.

After the process at step S521, the visual confirmation decision system 1 decides whether or not the elapsed time period from the gazing starting time point is equal to or longer than the visual confirmation completion time period (step S522). The decision at step S522 is performed by the visual confirmation decision unit 504. At the point of time at which the decision at step S522 is performed, the driver 8 is not viewing the road sign 9. Therefore, if the read out elapsed time period does not reach the visual confirmation completion time period, then it is considered that the driver 8 does not recognize the substance of the road sign 9. Accordingly, when the elapsed time period read out at step S521 is shorter than the visual confirmation completion time period (step S522: No), the visual confirmation decision system 1 outputs a message for notifying the driver 8 that the driver 8 fails to visually confirm the road sign 9 (step S523). The process at step S523 is performed, for example, by the visual confirmation decision unit 504. The visual confirmation decision unit 504 reads out a voice signal of a message for notifying the driver 8 that the gazing time period for the road sign 9 is short from the message 507d of the storage unit 507 and transmits the voice signal to the speaker 6. Thereafter, the visual confirmation decision system 1 changes the gazing state to a value representative of completion (for example, to “2”) (step S524), and then ends the gazing decision process.

On the other hand, if the elapsed time period read out at step S521 is equal to or longer than the visual confirmation completion time period (step S522: Yes), then the visual confirmation decision system 1 omits the process at step S523 and changes a state flag to a value representative of “decision completion” (step S524). Then, the gazing decision process is ended.

In this manner, in the gazing decision process of the present embodiment, a period of time (visual confirmation completion time period) taken for the driver 8 to recognize, for each road sign 9, the substance of the road sign 9 is estimated on the basis of the complexity of the road sign 9, the distance from the vehicle 7 to the road sign 9 and so forth. Then, from the relationship in magnitude between the estimated visual confirmation completion time period and the elapsed time period from the point of time at which the driver 8 starts gazing of the road sign 9, the visual confirmation decision system 1 decides whether or not the driver 8 recognizes the substance of the road sign 9. Therefore, in the gazing decision process of the present embodiment, erroneous decisions when it is decided on the basis of the sight line of the driver whether or not the driver visually confirms the road sign can be reduced.

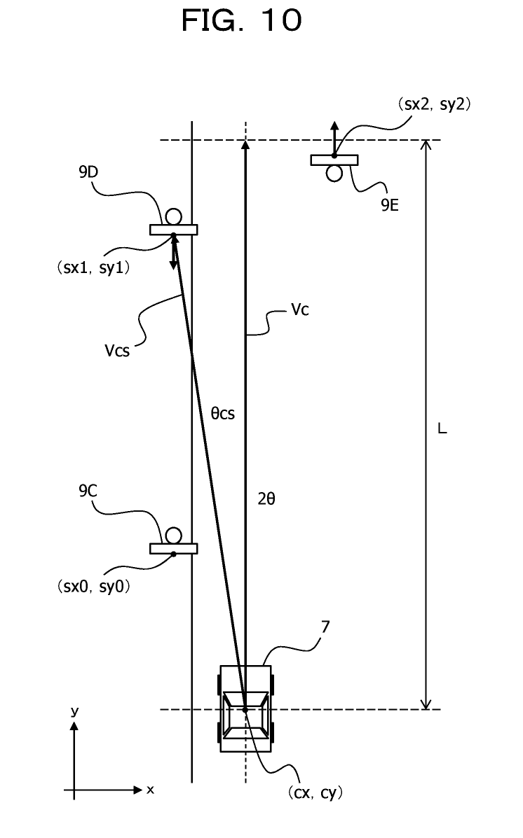

FIG. 10 is a view illustrating a searching method for a road sign. In the process of searching for a road sign in front of the vehicle (step S3), a road sign is searched for which exists within a distance L in an advancing direction of the vehicle 7 (direction of a vector Vc) as the center and besides within a range of an angle θ in a horizontal plane as depicted in FIG. 10. Thereupon, the sign searching unit 501 that performs the process at step S3 is first placed in the advancing direction of the vehicle 7 and searches for a road sign within the distance L from the vehicle 7. If it is assumed that the center position of the vehicle 7 in the coordinate system (xy coordinate system) of the ground is given by coordinates (cx, cy) and the position of the road sign is given by coordinates (sx, sy), then the distance Lcs from the vehicle 7 to the road sign is given by the following expression (1):

Lcs={(sx−cx)²+(sy−cy)²}^{1/2} (1)

At this state, all road signs whose distance Lcs is shorter than the distance L make a detection target. Accordingly, three road signs 9C, 9D and 9E are all detection targets in the example depicted in FIG. 10. Here, the distance L representative of the search range for a road sign is a value that can be changed suitably and is set, for example, to approximately 100 m.

Then, the sign searching unit 501 extracts, from among the road signs whose distance Lcs is shorter than the distance L, those road signs that exist within the range of the angle ±θ in the horizontal plane across the advancing direction of the vehicle 7 as the center. The angle θ cs in a direction from the center position of the vehicle 7 toward a road sign when the advancing direction of the vehicle 7 is taken as the center (0 degrees) can be calculated, for example, by the inner product of the vector Vc of the vehicle 7 in the advancing direction and the vector Vcs in the direction from the center of the vehicle 7 toward the road sign.

In particular, the sign searching unit 501 extracts, from among the road signs whose distance Lcs is shorter than the distance L, those road signs whose angle θ cs is smaller than the angle θ. Accordingly, in the example depicted in FIG. 10, road signs 9D and 9E except a road sign 9C placed at the coordinates (sx0, sy0) are extracted. Here, the angle ±θ representative of the search range for a road sign is a suitably changeable value and is, for example, within a range of ±5 degrees in the horizontal plane across the advancing direction of the vehicle as the center across the advancing direction of the vehicle.

Further, the sign searching unit 501 extracts, from among the road signs which exist in the distance L in the advancing direction of the vehicle 7 and within the range of the angle θ in the horizontal plane, only those road signs which present information to the driver 8 of the vehicle 7. Thereupon, the sign searching unit 501 decides, for example, on the basis of the orientation of each road sign, whether or not the road sign presents information to the driver 8 of the vehicle 7. In the example of FIG. 10, the road sign 9D placed at the coordinates (sx1, sy1) is oriented toward the vehicle 7. On the other hand, the road sign 9E placed at the coordinates (sx2, sy2) is oriented to the opposite direction to the direction of the vehicle 7. Therefore, in the example depicted in FIG. 10, it is decided that the road sign 9D placed at the coordinates (sx1, sy1) is a road sign that presents information to the driver 8. Therefore, in the example depicted in FIG. 10, the sign searching unit 501 transmits information only of the one road sign 9D from among the three road signs 9C, 9D and 9E to the sign direction calculation unit 502 and so forth.

It is to be noted that, in the process at step S3, for example, at the stage at which a road sign whose distance Lcs is shorter than the distance L is extracted, only a road sign or signs that present information to the driver 8 of the vehicle 7 may be extracted.

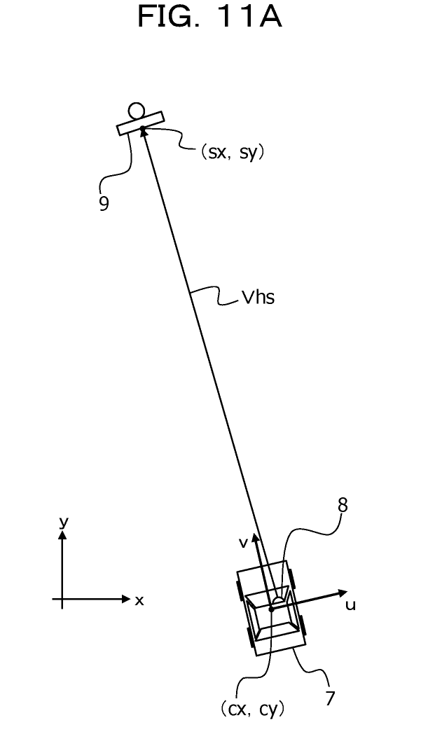

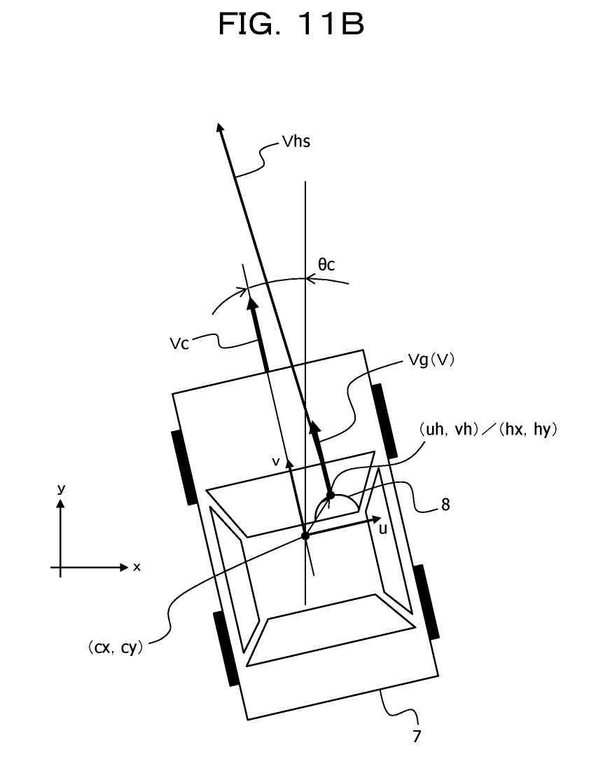

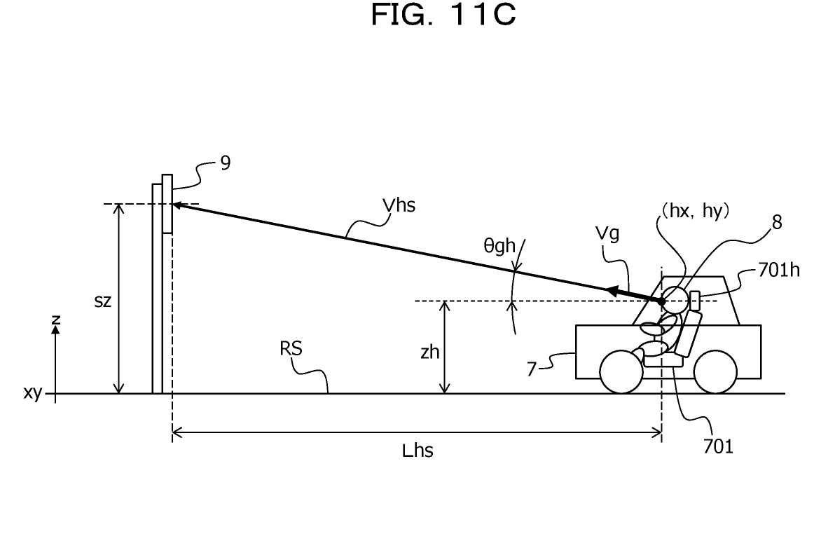

FIG. 11A is a view (part 1) illustrating a decision method of an overlap between a direction of a road sign and a sight line of a driver. FIG. 11B is a view (part 2) illustrating the decision method of the overlap between the direction of the road sign and the sight line of the driver. FIG. 11C is a view (part 3) illustrating the decision method of the overlap between the direction of the road sign and the sight line of the driver.

At step S504, it is detected whether or not the driver 8 is viewing the road sign 9, for example, depending upon whether or not the direction of the road sign calculated at step S502 and the direction of the sight line of the driver calculated at step S503 make an angle within a given angular range. Thereupon, the direction of the road sign and the direction of the sight line of the driver are calculated in the following manner after they are divided each into a component within the horizontal plane and a component in the heightwise direction.

When a component in the horizontal plane is to be calculated, it is assumed first that the center position of the vehicle 7 in the coordinate system of the ground (xy coordinate system) is represented by coordinates (cx, cy) and the position of the road sign is represented by coordinates (sx, sy) as depicted in FIGS. 11A and 11B. Further, the angle defined by the y-axis direction of the coordinate system of the ground and the advancing direction of the vehicle 7 is represented by θc, and the unit vector of the advancing direction of the vehicle 7 is represented by Vc=(cos θc, sin θc) as depicted in FIG. 11B.

Further, it is assumed that the position of the driver's seat is same as the position of the head of the driver 8 (origin of the point of view) and the relative position of the driver 8 (driver's seat) on a uv Cartesian coordinate system is defined as (uh, vh). Further the unit vector in the sight line direction in the uv Cartesian coordinate system is represented by Vg=(cos θg, sin θg). Here, the uv Cartesian coordinate system defines such that the vehicle advancing direction is the positive direction of the v axis and the vehicle rightward direction orthogonal to the v axis is the positive direction of the u axis.

At this time, the v axis extends in parallel to the vector Vc and the u axis extends in parallel to a vector (sin θc, −cos θc) obtained by rotating the vector Vc by −90 degrees. Therefore, if the head of the driver 8 in the coordinate system of the ground has coordinates (hx, hy), then the coordinates (hx, hy) are given by the following expressions (2-1) and (2-2), respectively:

hx=cx+uh·sin θc+vh·cos θc (2-1)

hy=cy+uh·(−cos θc)+vh·sin θc (2-2)

Accordingly, by applying the expressions (2-1) and (2-2) to the vector Vhs=(sx−hx, sy−hy) from the driver 8 (driver's seat) to the road sign 9 in the coordinate system of the ground, the vector Vhs can be represented using components of a unit vector in the uv coordinate system.

Similarly, the vector V=(Vx, Vy) in the sight line direction in the coordinate system of the ground is given by the following expressions (3-1) and (3-2) using components of a unit vector Vg in the uv coordinate system, respectively:

Vx=cos θg·sin θc+sin θg·cos θc (3-1)

Vy=sin θg·sin θc−cos θg·cos θc (3-2)

In particular, the sign direction calculation unit 502 calculates the vector Vhs described hereinabove and the sight line direction calculation unit 503 calculates the vector V in the sight line direction described hereinabove. Then, the visual confirmation decision unit 504 calculates, for example, the inner product of the two vectors Vhs and V to decide whether or not the orientations of the vectors are substantially same. If the orientations of the two vectors are same, then the inner product of them is 0. Therefore, it can be decided whether or not the driver 8 is viewing the road sign 9 depending upon whether or not the inner product of the vector Vhs and the vector V is 0 or a value within a threshold range near to 0. Consequently, it can be decided whether or not the driver 8 is viewing the road sign 9 within the horizontal plane depicted in FIGS. 11A and 11B.

Besides, when a component in the heightwise direction is to be calculated, it is assumed that the vertical upward direction of the coordinate system of the ground in the horizontal plane (xy coordinate system) is defined as a positive direction of the z axis, and the center position of the vehicle 7 in the z-axis direction is represented by cz and the center position of the road sign is represented by sz, as depicted in FIG. 11C.

Here, if the vector Vhs=(sx−hx, sy−hy) from the driver 8 (driver's seat 701) to the road sign 9 described hereinabove is used, then the distance Lhs from the driver 8 to the road sign 9 in a plane perpendicular to the horizontal plane (xy plane) is given by the following expression (4):

Lhs={(sx−hx)²+(sy−hy)²}^{1/2} (4)

Further, where the driver 8 is viewing the center of the road sign 9, if it is assumed that the height of the head of the driver 8 from the ground surface RS (height of the origin of the sight line) is the height zh of a headset 701h of the driver's seat 701 from the ground surface RS and the angle (elevation angle) of the heightwise direction of the sight line is represented by θ gh, the following expression (5) is satisfied:

tan θgh=(sz−zh)/Lhs (5)

Accordingly, for example, if the difference between the angle θ gh of the sight line calculated from the relationship of the expression (5) and the angle of the sight line calculated using the pupil-cornea reflection method is within a given angular range, then it can be decided that the driver 8 is viewing the road sign 9. This makes it possible to decide whether or not the driver 8 is viewing the road sign 9 in the heightwise direction depicted in FIG. 11C.

It is to be noted that, since, in almost all vehicles 7, the position of the driver's seat 701 is not the center position (cx, cy) of the vehicle 7, in the foregoing description, the position of the driver's seat 701 is calculated adding an offset (uh, vh). Further, in the foregoing description, the position of the driver's seat 701 (position of the headrest 701h) is determined as the position of the head of the driver 8 (origin of the sight line). However, the position of the head of the driver 8 is not limited to this, and it is a matter of course that a more accurate position may be determined using a sensor or the like. Alternatively, information of the physique of the driver 8 may be retained such that the position of the head is calculated from the information. Further, in the present embodiment, while the height of the head of the driver 8 from the ground is determined as the height zh of the headrest 701h of the driver's seat, the height of the head of the driver 8 is not limited to this, but a different sensor may be used to detect the height of the origin of the sight line of the driver 8 and use the detected height in place of zh of the expression (5). It is to be noted that it is assumed here that the vehicle 7 and the road sign 9 exist on a flat road. If the vehicle 7 is traveling on a sloping road, the directions of the sight line of the driver 8 and the road sign in the heightwise direction may be calculated taking the slope (inclination angle) of the road surface into consideration.

Further, when it is decided whether or not the driver 8 is viewing the road sign 9 by the method described above, for example, the direction in which the display surface of the road sign 9 faces may be taken into consideration. This makes it possible to decide it more accurately whether or not the driver 8 is viewing the road sign 9.

Now, a calculation method for an estimation value of the visual confirmation degree and a visual confirmation completion time period is described.

An estimation value of the visual confirmation degree to be calculated by the visual confirmation degree estimation unit 505 is calculated in accordance with such an expression that, as the complexity of a road sign increases, the visual confirmation degree decreases as described above. The complexity C of a road sign is calculated, for example, using the following expression (6):

C=cnc·nc+cnw·nw+cnr·nr (6)

In the expression (6) above, nc, nw and nr represent the number of characters, the number of words and the number of routes of the road sign information, respectively. Further, cnc, cnw and cnr in the expression (6) represent weight coefficients of the complexity for the number of characters, the number of words and the number of routes, respectively. The weight coefficients cnc, cnw and cnr of the complexity may be derived experimentally or through actual measurement. As the character number nc, word number nw and route number nr of the road sign information increase in value, the substance of the road sign 9 becomes complex and the complexity C obtained from the expression (6) exhibits a higher value. Further, as the substance of the road sign 9 is complicated, it becomes difficult for the driver 8 to recognize the substance of the road sign 9 in a short period of time. Therefore, the visual confirmation degree U is given, for example, by U=1/C.

The value of the visual confirmation degree U calculated in this manner exhibits a higher value as the complexity C decreases. In other words, as the value of the visual confirmation degree U increases, it becomes easier for the driver 8 to recognize the road sign 9 and the visual confirmation completion time period becomes shorter. However, as the distance from the vehicle 7 to the road sign 9 increases, the road sign 9 looks smaller to the driver 8 and the driver 8 is less likely to recognize the road sign 9, resulting in increase of the visual confirmation completion time period. However, as the speed of the vehicle 7 increases, the road sign 9 looks greater to the driver 8 in a shorter period of time, and the situation in which it is less easy for the driver 8 to recognize the road sign 9 is improved. Therefore, taking such factors as described above which have an influence on the ease of recognition of the road sign 9 into consideration, the visual confirmation completion time period Dt is calculated, for example, in accordance with the following expression (7):

Dt=Kt×{Lhs/(U×Cv)} (7)

Lhs and Cv in the expression (7) represent the distance from the vehicle 7 to the road sign 9 and the speed of the vehicle 7, respectively. Further, Kt in the expression (7) represents a time coefficient and is used for real time adjustment. The time coefficient Kt may be derived experimentally or through actual measurement.

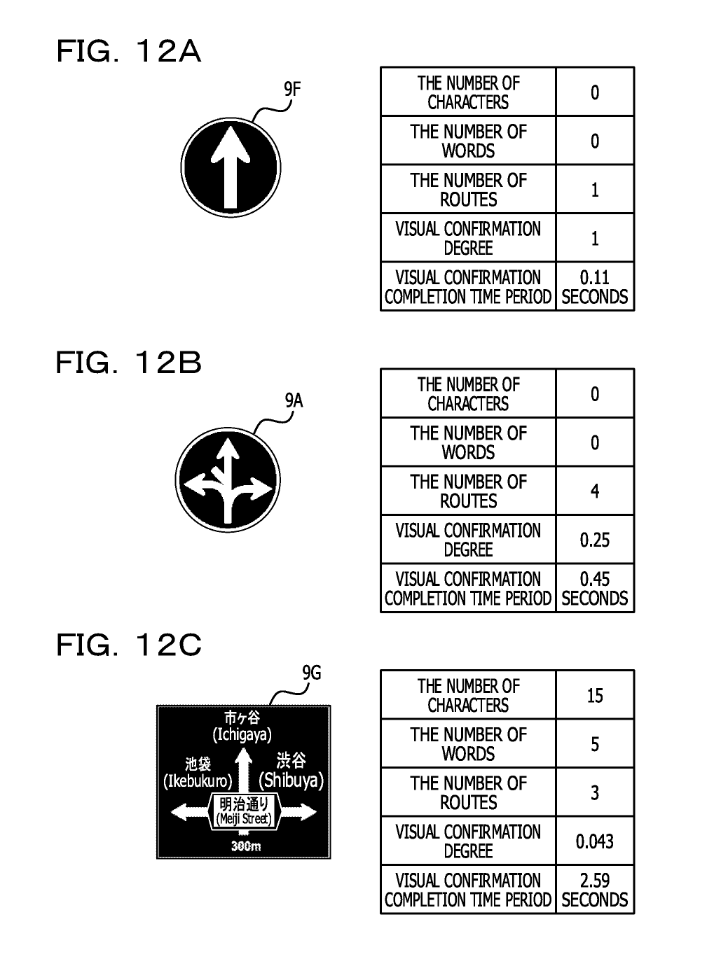

FIGS. 12A to 12C are views illustrating an example of calculation of a visual confirmation degree and a visual confirmation completion time period.

FIG. 12A depicts a road sign 9F that indicates that the number of routes is one and advancement in a direction other than a specified direction is inhibited. In the road sign information of the road sign 9F, the character number nc and the word number nw are zero and the route number nr is one. Therefore, if the weight coefficients cnc, cnw and cnr in the expression (6) are all set to one to calculate the complexity C and then the visual confirmation degree U is calculated using the calculated complexity C, then U=1.0 is obtained. Further, if it is assumed that the speed Cv of the vehicle 7 is 16 m/second (=57.6 km/hour) and the distance Lhs from the driver's seat of the vehicle 7 to the road sign 9 is 60 m and besides the time coefficient Kt is 0.03, then from the expression (7), the visual confirmation completion time period Dt is 0.11 seconds.

FIG. 12B depicts a road sign 9A that indicates that the number of routes is four and advancement in a direction other than the specified directions is inhibited. In the road sign information of the road sign 9A, the character number nc and the word number nw are zero and the route number nr is four. Therefore, if the weight coefficients cnc, cnw and cnr in the expression (6) are all set to one to calculate the complexity C and then the visual confirmation degree U is calculated using the calculated complexity C, then U=0.25 is obtained. Further, if the speed Cv of the vehicle 7 is 16 m/second (=57.6 km/hour) and the distance Lhs from the driver's seat of the vehicle 7 to the road sign 9 is 60 m and besides the time coefficient Kt is 0.03, then the visual confirmation completion time period Dt is 0.45 seconds from the expression (7). Even with a road sign that indicates inhibition of advancement in a direction other than the specified direction or directions, since the complexity C increases as the number of routes increases in this manner, the visual confirmation completion time period Dt under the same condition is longer with regard to the road sign 9A that has a greater number of route.

FIG. 12C depicts a road sign 9G that is a kind of an information sign and gives notice of districts, directions and common names of roads. In this road sign 9G, an arrow mark indicative of a route is branched to three directions, and characters representative of districts associated with the directions are described. Further, in the road sign 9G, common names of the roads and distance to a branch point are described. The character number nc of the road sign 9G is, for example, totaling 15 characters including “ [symbol] “(Ichigaya, three characters), “ [symbol] ” (Ikebukuro, two characters), “ [symbol] ” (Shibuya, two characters), “ [symbol] ” (Meiji Street, four characters) and “300 m” (300 m, four characters). Meanwhile, the word number nw is five (“ [symbol] ”, “ [symbol] ”, “ [symbol] ” “ [symbol] ” and “300 m”). Further, the route number nr is three. Therefore, if all of the weight coefficients cnc, cnw and cnr in the expression (6) are set to 1 to calculate the complexity C and then the visual confirmation degree U is calculated using the calculated complexity C, then U=0.043 is obtained. Further, where the speed of the vehicle is 16 m/second (=57.6 km/hour) and the distance Lhs from the driver's seat of the vehicle to the road sign is 60 m and besides the time coefficient Kt is 0.03, then the visual confirmation completion time period Dt is 2.59 seconds from the expression (7). Even where the number of routes is three, since the complexity C increases as the number of characters increases in this manner, the visual confirmation completion time period under the same condition becomes long in comparison with those of the road signs 9A and 9F.

As described above, in the visual confirmation decision system 1 according to the present embodiment, if a road sign 9 placed forwardly of the vehicle 7 (advancing direction) is detected, then a visual confirmation degree indicative of ease of visual confirmation of the road sign 9 is estimated on the basis of the substance described on the display face of the road sign 9. Further, the visual confirmation decision system 1 calculates a period of time (visual confirmation completion time period) taken for the driver 8 to recognize the substance of the road sign 9 using the estimated visual confirmation degree, the speed of the vehicle 7 and the distance from the vehicle 7 to the road sign 9. Thereupon, the visual confirmation decision system 1 calculates an estimation value of the visual confirmation degree and a visual confirmation completion time period such that, as the complexity of the substance described on the surface of the road sign 9 increases, the visual confirmation completion time period increases. Then, if the period of time for which the driver 8 continuously gazes the road sign 9 exceeds the visual confirmation completion time period, then the visual confirmation decision system 1 decides that the driver 8 has recognized the substance of the road sign 9. In other words, if the sight line of the driver 8 is displaced from the road sign 9 before the period of time for which the road sign 9 is continuously gazed reaches the visual confirmation completion time period, then the visual confirmation decision system 1 decides that the driver 8 does not recognize the substance of the road sign 9 correctly. Therefore, with the visual confirmation decision system 1 of the present embodiment, the accuracy in decision of whether or not the driver 8 recognizes the substance of the road sign 9 correctly can be improved.

Further, if the driver 8 continues to gaze the road sign 9 even if the period of time for which the driver 8 continuously gazes the road sign 9 exceeds the visual confirmation completion time period, then the visual confirmation decision system 1 outputs a message to the driver 8. Therefore, such a situation that the driver 8 continues to view the road sign 9 and becomes careless of the front can be suppressed.

Further, the visual confirmation decision system 1 detects a road sign 9 placed in the advancing direction of the vehicle on the basis of the position and the orientation of the vehicle 7 and the road sign information 507a and outputs, if the driver 8 does not gaze the detected road sign 8 within a given period of time, a message to the driver 8. Therefore, the possibility that the driver 8 may overlook a road sign 9 that overlaps with, for example, a tree branch and is less likely to be noticed by the driver 8 can be reduced.

It is to be noted that, while, in the present embodiment, the visual confirmation degree U is calculated using the character number nc, word number nw and route number nr of the road sign 9, calculation of the visual confirmation degree U is not limited to this, and the visual confirmation degree U may be calculated including graphic shape vector number nv or/and a placement ratio rt.

Further, when the visual confirmation completion time period Dt is to be calculated, a coefficient determined, for example, taking the steering angle of the steering member, the operation amount of the acceleration pedal, the position of the wiper switch and so forth into consideration may be additionally applied to the expression (7). For example, when the vehicle 7 is traveling along a curve or is to turn to the right or to the left, it may be demanded for the driver 8 to recognize the substance of a road sign while confirming the safety in the advancing direction of the vehicle, and therefore, it is considered that the period of time taken for visual confirmation increases in comparison with that when the vehicle is traveling straightforwardly. Therefore, when to calculate the visual confirmation completion time period, a coefficient that increases the visual confirmation completion time period as the absolute value of the steering angle of the steering member increases may be added. Further, it is considered that, in a rainy weather, as the rain amount increases, the field of view forwardly of the vehicle deteriorates and the time taken for visual confirmation of a road sign increases. Further, as the rain amount increases, the operation speed of the wiper increases (the value of the wiper position increases). Therefore, when to calculate the visual confirmation completion time period, such a coefficient as increases the visual confirmation completion time period as the value of the wiper position increases may be added.

Further, since a message to the driver 8 is outputted at steps S508, S518 and S523, preferably the speaker 6 is used to output voice as described hereinabove. However, the message to the driver 8 in the visual confirmation decision system 1 is not limited to voice and may be beep sound that differs, for example, in pitch or utterance pattern. Further, in place of outputting voice or beep sound using the speaker 6, such a method as vibrating the steering member (steering wheel) or blinking a lamp provided on an instrument panel may be used to notify the driver 8 of a result of decision.

### Second Embodiment

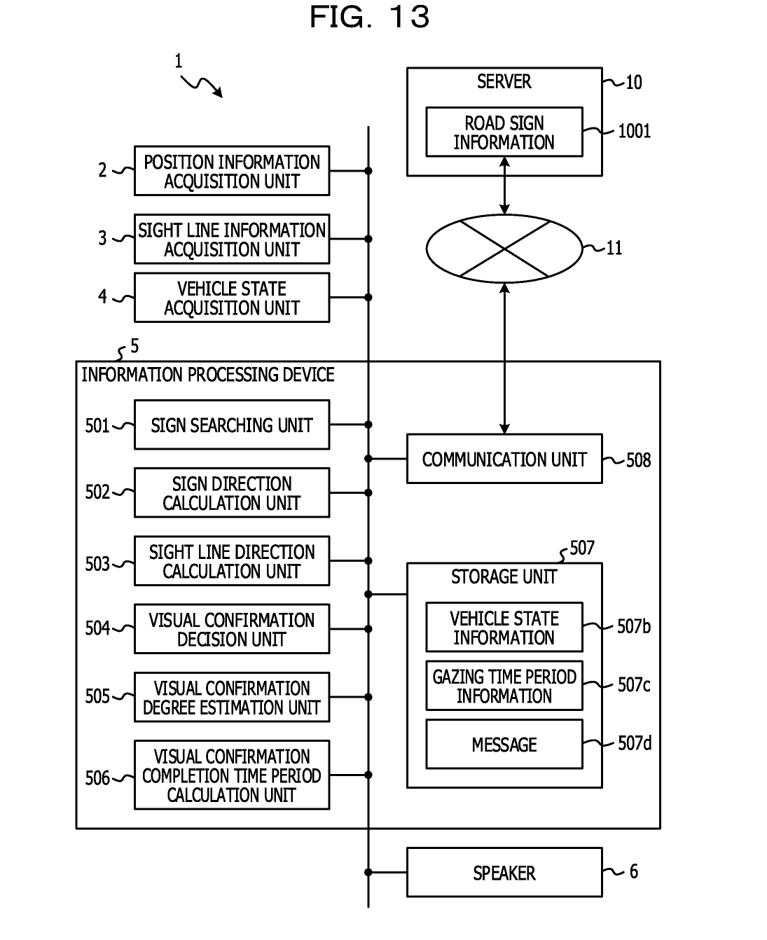

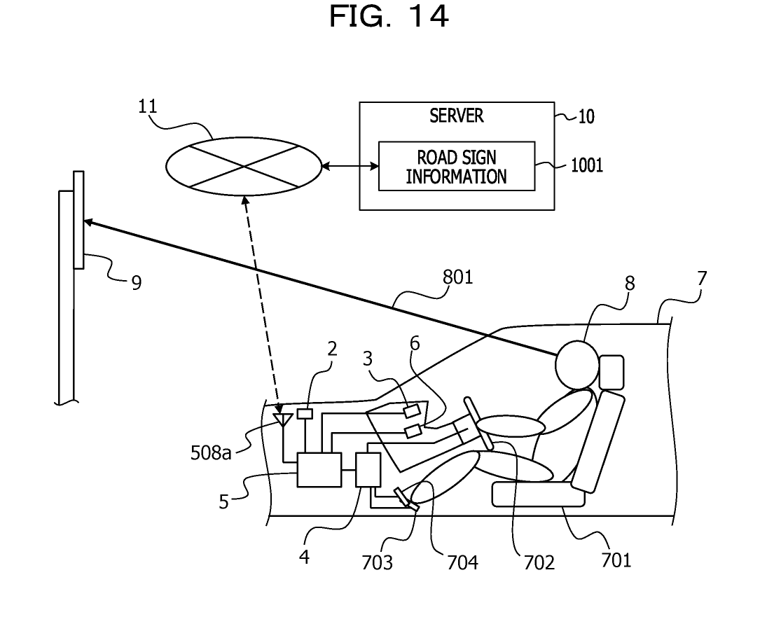

FIG. 13 is a block diagram depicting a functional configuration of a road sign visual confirmation decision system according to a second embodiment. FIG. 14 is a view depicting an example of provision of the road sign visual confirmation decision system according to the second embodiment.

As depicted in FIG. 13, a road sign visual confirmation decision system 1 according to the present embodiment includes a position information acquisition unit 2, a sight line information acquisition unit 3, a vehicle state acquisition unit 4, an information processing device 5, a speaker 6 and a server 10.

The position information acquisition unit 2 acquires position information of the vehicle 7 including the position and the orientation of the vehicle 7. The sight line information acquisition unit 3 acquires sight line information to be used to calculate the direction of the sight line of the driver 8. The vehicle state acquisition unit 4 acquires various kinds of information indicative of a state of the vehicle 7 including the speed of the vehicle 7, the steering angle of the steering member and so forth.

The information processing device 5 decides, on the basis of the position information and the vehicle state of the vehicle 7, the direction of the sight line 801 of the driver 8 and information regarding a road sign 9 placed in front of the vehicle 7, whether or not the driver 8 recognizes the substance of the road sign 9. The information processing device 5 in the present embodiment includes, similarly as in the information processing device 5 in the first embodiment, a sign searching unit 501, a sign direction calculation unit 502, a sight line direction calculation unit 503, a visual confirmation decision unit 504, a visual confirmation degree estimation unit 505, a visual confirmation completion time period calculation unit 506, and a storage unit 507. The information processing device 5 further includes a communication unit 508. The communication unit 508 communicates with the server 10 through a communication network 11 such as the Internet and acquires information of a desired road sign from road sign information 1001 retained by the server 10. The road sign information 1001 of the server 10 includes information similar to that of the road sign information 507a (refer to FIG. 3) described hereinabove in connection with the first embodiment.

In the road sign visual confirmation decision system 1 of the present embodiment, the position information acquisition unit 2, sight line information acquisition unit 3, vehicle state acquisition unit 4, information processing device 5 and speaker 6 are incorporated in the vehicle 7 as depicted in FIG. 14. Thus, the information processing device 5 acquires road sign information from the server 10 through the communication network 11. In other words, in the visual confirmation decision system 1 according to the present embodiment, in place of storing road sign information into the storage unit 507 of each of the information processing device 5 incorporated in different vehicles 7, the road sign information 1001 of the server 10 is shared by a plurality of information processing device 5.

The visual confirmation decision process performed by the visual confirmation decision system 1 of the present embodiment may be same as that described hereinabove in connection with the first embodiment except whether road sign information is read out from the storage unit 507 or acquired from the server 10.

Where the road sign information 1001 is retained in the server 10 as in the case of the visual confirmation decision system 1 of the present embodiment, it is possible for a plurality of information processing device 5 to use the same road sign information 1001 to perform a search for a road sign 9 or estimation of the visual confirmation degree. This facilitates management of road sign information including updating (rewriting) of road sign information when a road sign 9 is installed newly or is removed.

### Third Embodiment

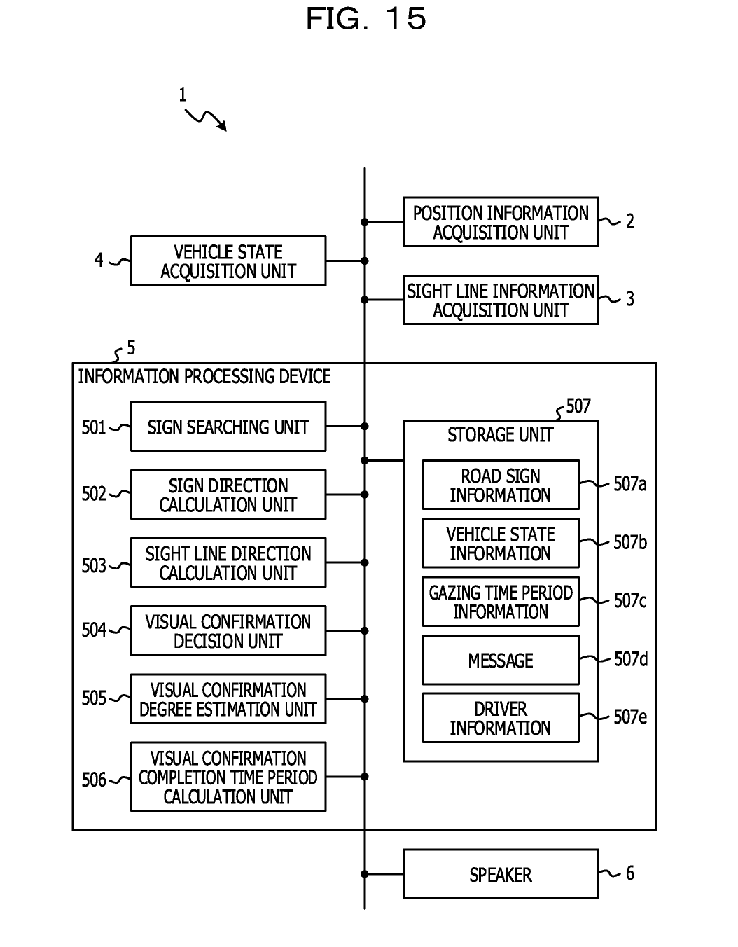

FIG. 15 is a block diagram depicting a functional configuration of a road sign visual confirmation decision system according to a third embodiment.

As depicted in FIG. 15, a road sign visual confirmation decision system 1 according to the present embodiment includes a position information acquisition unit 2, a sight line information acquisition unit 3, a vehicle state acquisition unit 4, an information processing device 5 and a speaker 6.

The position information acquisition unit 2 acquires position information of the vehicle including the position and the orientation of the vehicle. The sight line information acquisition unit 3 acquires sight line information used to calculate the direction of the sight line of the driver 8. The vehicle state acquisition unit 4 acquires various kinds of information indicative of a state of the vehicle 7 including the speed of the vehicle 7, the steering angle of the steering member and so forth.

The information processing device 5 decides, on the basis of the position information and the vehicle state of the vehicle 7, the direction of the sight line 801 of the driver 8, information regarding a road sign 9 placed in front of the vehicle 7 and driver information, whether or not the driver 8 recognizes the substance of the road sign 9. The information processing device 5 in the present embodiment includes, similarly as in the information processing device 5 in the first embodiment, a sign searching unit 501, a sign direction calculation unit 502, a sight line direction calculation unit 503, a visual confirmation decision unit 504, a visual confirmation degree estimation unit 505, a visual confirmation completion time period calculation unit 506, and a storage unit 507.

It is to be noted that, in the storage unit 507 of the information processing device 5 in the present embodiment, driver information 507e is stored in addition to the road sign information 507a, vehicle state information 507b, gazing time period information 507c and message 507d.

The driver information 507e is information regarding the driver 8 who has a correlation with the visual confirmation completion time period and includes, for example, information of the binocular visual acuity of the driver 8 and so forth. The driver information 507e is used to calculate the visual confirmation completion time period Dt by the visual confirmation completion time period calculation unit 506. If the driver 8 has a high binocular visual acuity, then the driver 8 can recognize the substance (characters or a figure) of the road sign 9 even at a stage at which, for example, the distance from the vehicle 7 to the road sign 9 is long and therefore the apparent dimension of the road sign 9 is small. Therefore, when a plurality of drivers having different binocular visual acuities recognize the substance of a road sign 9 of the same substance at a fixed distance from the vehicle 7 to the road sign 9, it is considered that a driver having a higher binocular visual acuity can recognize the substance of the road sign 9 in a shorter period of time. Therefore, in the present embodiment, the visual confirmation completion time period Dt suitable for each driver 8 is calculated using the following expression (8) that takes the binocular visual acuity of the driver 8 into consideration:

Dt=Ktv×{Lhs/(U×Cv×Vp)} (8)

In the expression (8), Vp represents the binocular visual acuity. Lhs and Cv in the expression (8) represent the distance from the vehicle 7 (driver 8) to the road sign 9 and the speed of the vehicle 7, respectively. Further, Ktv in the expression (8) represents a time coefficient and is used for actual time adjustment. The time coefficient Ktv may be derived experimentally or through actual measurement.

In this manner, since the visual confirmation decision system 1 of the present embodiment calculates the visual confirmation completion time period suitable for each driver 8 taking the visual acuity (binocular visual acuity) of the driver 8 into consideration, the accuracy in decision of whether or not the driver 8 correctly recognizes the substance of the road sign 9 can be improved further.

It is to be noted that the driver information used for calculation of the visual confirmation completion time period Dt may include, in addition to the visual acuity of the driver, for example, the age, driving experience, sex and so forth of the driver. Where the age of the driver is used for calculation of the visual confirmation completion time period Dt, the coefficient is set such that the visual confirmation completion time period Dt for a young driver (driver having short driving experience) or an aged driver becomes longer than that for a driver of any other age and the right side of the expression (7) or (8) is multiplied by the coefficient.

Further, the configuration of the visual confirmation decision system 1 of the present embodiment is not limited to that depicted in FIG. 15, but the visual confirmation decision system 1 may be configured otherwise such that the information processing device 5 acquires road sign information from the server 10 through the communication network 11 as described hereinabove in connection with the second embodiment.

### Fourth Embodiment

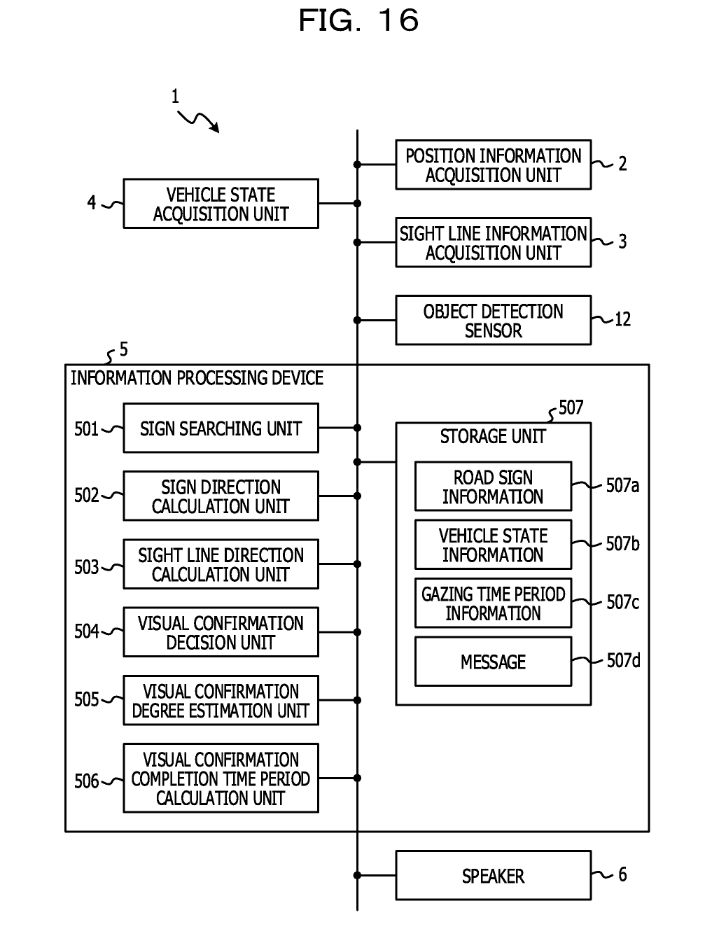

FIG. 16 is a block diagram depicting a functional configuration of a road sign visual confirmation decision system according to a fourth embodiment.

As depicted in FIG. 16, a road sign visual confirmation decision system 1 according to the present embodiment includes a position information acquisition unit 2, a sight line information acquisition unit 3, a vehicle state acquisition unit 4, an information processing device 5, a speaker 6 and an object detection sensor 12.

The position information acquisition unit 2 acquires position information of the vehicle 7 including the position and the orientation of the vehicle 7. The sight line information acquisition unit 3 acquires sight line information used to calculate the direction of the sight line of the driver 8. The vehicle state acquisition unit 4 acquires various kinds of information indicative of a state of the vehicle 7 including the speed of the vehicle 7, the steering angle of the steering member and so forth.

The information processing device 5 decides whether or not the substance of a road sign 9 is recognized by the driver 8 on the basis of the position information and the vehicle state of the vehicle 7, the direction of the sight line 801 of the driver 8 and the road sign 9 disposed in front of the vehicle 7. The information processing device 5 in the present embodiment includes a sign searching unit 501, a sign direction calculation unit 502, a sight line direction calculation unit 503, a visual confirmation decision unit 504, a visual confirmation degree estimation unit 505, a visual confirmation completion time period calculation unit 506 and a storage unit 507 similarly to the information processing device 5 of the first embodiment.

The object detection sensor 12 is a sensor for detecting the position, shape and so forth of an object existing in the forward direction of the vehicle (direction in which the vehicle advances). As the object detection sensor 12, for example, a millimeter wave radar device that is used for detection of an obstacle or the like can be used.

The sign searching unit 501 in the first embodiment searches for a road sign 9 existing in the advancing direction of the vehicle 7 using the information of the position and the orientation of the vehicle 7 acquired by the position information acquisition unit 2 and the information of the placement position of the road sign information 507a.

In contrast, the sign searching unit 501 in the visual confirmation decision system 1 of the present embodiment detects a road sign 9 existing in the forward direction of the vehicle (advancing direction) using a result of detection of an object existing in front of the vehicle by the object detection sensor 12. Thereupon, the sign searching unit 501 can detect an existing road sign 9 and the position of the road sign 9 on the basis of a result of detection by the object detection sensor 12. Also it is possible for the sign searching unit 501 to detect a road sign from a combination of a result of detection by the object detection sensor 12, the information of the position and the orientation of the vehicle acquired by the position information acquisition unit 2 and the road sign information 507a.

The object detection sensor 12 is a sensor for detecting the position, shape and so forth of an article existing within a given range. Therefore, by using the object detection sensor 12, it is possible to detect an accurate position of a road sign 9 existing in the advancing direction of the vehicle 7. Accordingly, in the visual confirmation decision system 1 of the present embodiment, it is possible to detect, for example, the position at present of the road sign 9 whose installation position or orientation is changed after it is placed. Therefore, it is possible to suppress such erroneous detections that, although the driver 8 is viewing the road sign 9, the displacement between the direction of the road sign 9 calculated on the basis of the road sign information 507a and the actual direction of the road sign 9 causes the visual confirmation decision unit 504 to decide that the driver 8 is not viewing the road sign 9.

It is to be noted that the configuration of the visual confirmation decision system 1 of the present embodiment is not limited to that depicted in FIG. 16 and the visual confirmation decision system 1 may be configured otherwise such that the information processing device 5 acquires road sign information from the server 10 through the communication network 11 as described hereinabove in connection with the second embodiment.

Further, the visual confirmation decision system 1 of the present embodiment may be configured such that the visual confirmation completion time period Dt is calculated taking also the driver information 507e described hereinabove in connection with the third embodiment into consideration.

### Fifth Embodiment

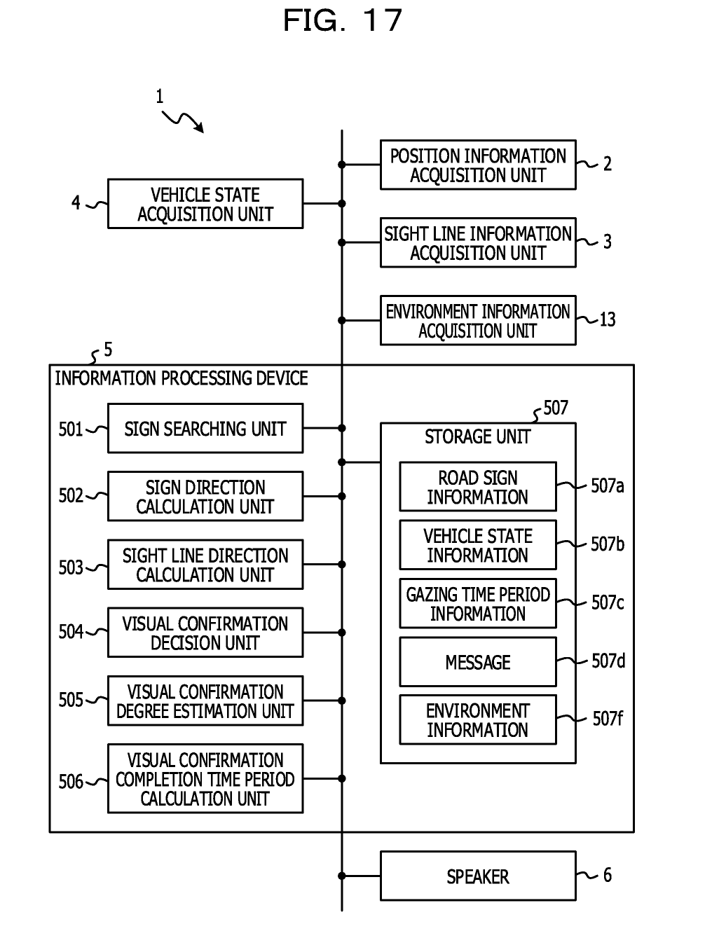

FIG. 17 is a block diagram depicting a functional configuration of a road sign visual confirmation decision system according to a fifth embodiment.

As depicted in FIG. 17, a road sign visual confirmation decision system 1 according to the present embodiment includes a position information acquisition unit 2, a sight line information acquisition unit 3, a vehicle state acquisition unit 4, an information processing device 5, a speaker 6 and an environment information acquisition unit 13.

The position information acquisition unit 2 acquires position information of the vehicle 7 including the position and the orientation of the vehicle 7. The sight line information acquisition unit 3 acquires sight line information used to calculate the direction of the sight line of the driver 8. The vehicle state acquisition unit 4 acquires various kinds of information indicative of a state of the vehicle 7 including the speed of the vehicle 7, the steering angle of the steering member and so forth.

The environment information acquisition unit 13 acquires environment information around the vehicle. The environment information acquired by the environment information acquisition unit 13 is information around the vehicle which has a correlation with the visual confirmation completion time period and includes, for example, information regarding the brightness (illuminance) around the vehicle.

The information processing device 5 decides whether or not the substance of the road sign 9 is recognized by the driver 8 on the basis of the position information and the vehicle state of the vehicle 7, the direction of the sight line 801 of the driver 8, information regarding the road sign 9 placed in front of the vehicle 7 and the environment information. The information processing device 5 in the present embodiment includes a sign searching unit 501, a sign direction calculation unit 502, a sight line direction calculation unit 503, a visual confirmation decision unit 504, a visual confirmation degree estimation unit 505, a visual confirmation completion time period calculation unit 506 and a storage unit 507 similarly to the information processing device 5 in the first embodiment.

It is to be noted that, into the storage unit 507 of the information processing device 5 in the present embodiment, environment information 507f acquired by the environment information acquisition unit 13 is stored in addition to the road sign information 507a, vehicle state information 507b, gazing time period information 507c and message 507d. The environment information 507f is used when the visual confirmation completion time period calculation unit 506 calculates the visual confirmation completion time period Dt. In the daytime of a cloudy day, it is bright around the vehicle 7 and the road sign 9, the driver 8 is likely to visually recognize the road sign 9. In contrast, before or after the sunset or at night, it is dark around the vehicle 7 or the road sign 9, and therefore, there is the possibility that time may be taken for the driver 8 to visually recognize the road sign 9. In the present embodiment, the visual confirmation completion time period Dt in accordance with a surrounding environment is calculated using the following expression (9) that takes such ease of recognition of the road sign 9 in response to an environment around the vehicle as described above into consideration:

Dt=Ktv×{Lhs/(U×Cv×E)} (9)

In the expression (9), E represents an environment coefficient set on the basis of the ambient brightness. Lhs and Cv in the expression (9) represent the distance from the vehicle 7 (driver 8) to the road sign 9 and the speed of the vehicle 7, respectively. Further, Ktv in the expression (9) is a time coefficient and is a constant for real time adjustment. The time coefficient Ktv may be derived experimentally or through actual measurement.

Since the visual confirmation decision system 1 of the present embodiment calculates the visual confirmation completion time period taking the environment around the vehicle into consideration in this manner, the accuracy in decision of whether or not the substance of the road sign 9 is recognized correctly by the driver can be improved much more.

It is to be noted that the environment information acquired by the environment information acquisition unit 13 is not limited to information relating to the brightness around the vehicle but may be information including, for example, the weather, temperature, humidity and so forth around the vehicle. If the environment information including the temperature around the vehicle is acquired, then, for example, when the field of vision is degraded by fog or the like, it becomes possible to increase the visual confirmation completion time period of the road sign 9 from that when the weather is clear.

Further, the configuration of the visual confirmation decision system 1 of the present embodiment is not limited to that depicted in FIG. 17 and the visual confirmation decision system 1 may be configured otherwise such that the information processing device 5 acquires road sign information from the server 10 through the communication network 11 as described hereinabove in connection with the second embodiment.

Further, the visual confirmation decision system 1 of the present embodiment may be configured otherwise such that it includes the object detection sensor 12 described hereinabove in connection with the fourth embodiment.

Further, the visual confirmation decision system 1 of the present embodiment may be configured otherwise such that the visual confirmation completion time period Dt is calculated taking also the driver information 507e described hereinabove in connection with the third embodiment into consideration.

### Sixth Embodiment

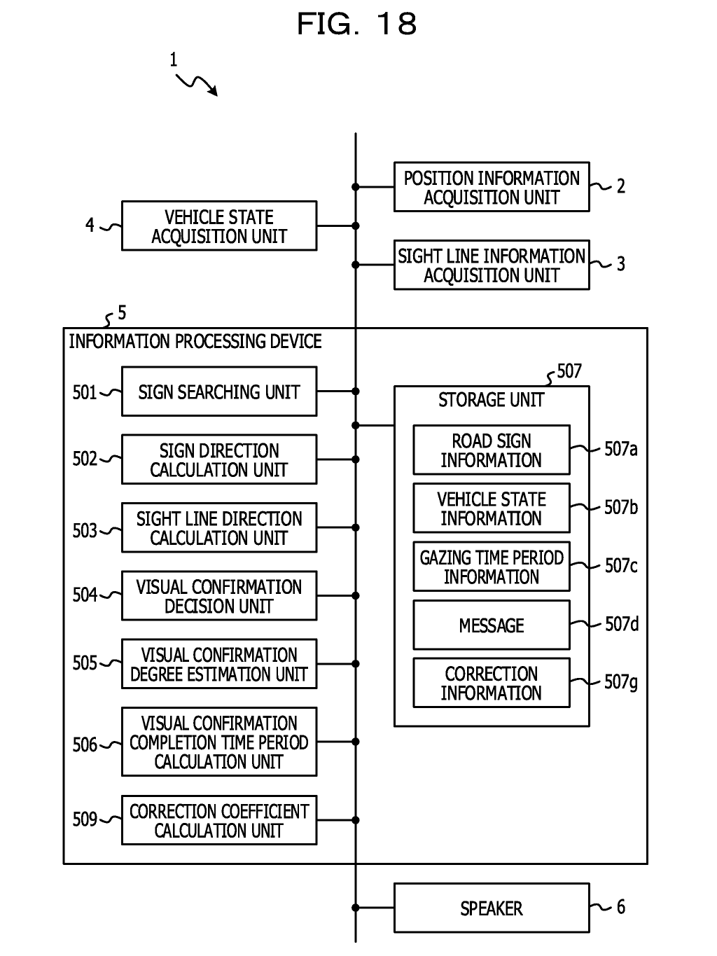

FIG. 18 is a block diagram depicting a functional configuration of a road sign visual confirmation decision system according to a sixth embodiment.

As depicted in FIG. 18, a road sign visual confirmation decision system 1 according to the present embodiment includes a position information acquisition unit 2, a sight line information acquisition unit 3, a vehicle state acquisition unit 4, an information processing device 5 and a speaker 6.

The position information acquisition unit 2 acquires position information of the vehicle 7 including the position and the orientation of the vehicle 7. The sight line information acquisition unit 3 acquires sight line information used to calculate the direction of the sight line of the driver 8. The vehicle state acquisition unit 4 acquires various kinds of information indicative of a state of the vehicle 7 including the speed of the vehicle 7, the steering angle of the steering member and so forth.

The information processing device 5 decides whether or not the substance of the road sign 9 is recognized by the driver 8 on the basis of the position information and the vehicle state of the vehicle 7, the direction of the sight line 801 of the driver 8 and information regarding a road sign 9 placed in front of the vehicle 7. The information processing device 5 according to the present embodiment includes a sign searching unit 501, a sign direction calculation unit 502, a sight line direction calculation unit 503, a visual confirmation decision unit 504, a visual confirmation degree estimation unit 505, a visual confirmation completion time period calculation unit 506 and a storage unit 507 similarly to the information processing device 5 in the first embodiment. The information processing device 5 in the present embodiment further includes a correction coefficient calculation unit 509. The correction coefficient calculation unit 509 calculates a correction coefficient to be used to perform correction for the visual confirmation completion time period calculated by the visual confirmation completion time period calculation unit 506 taking a visual confirmation result of a road sign in the past of the driver into consideration. Further, the correction coefficient calculation unit 509 stores correction information 507g including the calculated correction coefficient into the storage unit 507. The visual confirmation result of a road sign in the past of the driver is extracted, for example, from the gazing time period information 507c of the storage unit 507. Therefore, in the information processing device 5 in the present embodiment, the gazing time period information 507c, for example, for several days to several months is accumulated.

The correction coefficient calculation unit 509 reads out, when a processing timing determined in advance comes, for example, the gazing time period information 507c, calculates a difference value or a ratio between the elapsed time period from the gazing starting time point and the visual confirmation completion time period for each road sign, and calculates an average value of the difference value or the ratio. The correction coefficient calculation unit 509 determines the calculated average value of the difference value or the ratio as a correction coefficient and stores the correction information into the storage unit 507. When an average value of the difference value is calculated, the correction coefficient calculation unit 509 stores, into the storage unit 507, correction information indicating that the correction coefficient is added to or is subtracted from the visual confirmation completion time period Dt calculated using, for example, the expression (7), (8), (9) or the like. Besides, when an average value of the ratio is calculated, the correction coefficient calculation unit 509 stores, into the storage unit 507, correction information indicating that correction for multiplying the visual confirmation completion time period calculated using, for example, the expression (7) or the like by the correction coefficient is to be performed.

Thereafter, the visual confirmation completion time period calculation unit 506 performs correction based on the correction information 507g of the storage unit 507 for the visual confirmation completion time period calculated using the expression (7) or the like and records the visual confirmation completion time period after the correction into the gazing time period information. This makes it possible to calculate a visual confirmation completion time period more proximate to a time period taken for the driver 8 to recognize the substance of the road sign actually. Therefore, erroneous decisions by the visual confirmation decision unit 504 caused by displacement between an actual visual confirmation completion time period of the driver 8 and the visual confirmation completion time period calculated using the expression (7) or the like can be reduced.

It is to be noted that, when a correction coefficient is calculated, an average value, for example, for each sign category may be calculated in place of calculating an average value using all information included in the gazing time period information 507c. Alternatively, when a correction coefficient is calculated, individual recognition IDs of road signs included in the gazing time period information 507c may be used such that a correction coefficient is calculated in response to an appearance frequency of gazing time period information having a same individual recognition ID. Where the individual recognition ID of a road sign 9 exhibits a high appearance frequency, it is considered that the driver 8 frequently passes a road on which the road sign 9 is placed using the vehicle 7 and understands the position and the substance of the road sign 9. In such a case, since there is the tendency that the time period for which the driver 8 successively gazes the road sign 9 becomes shorter, such a correction coefficient that reduces the visual confirmation completion time period calculated using the expression (7) or the like is calculated. Consequently, erroneous decisions that the gazing time period is insufficient can be suppressed.

Further, the visual confirmation decision system 1 of the present embodiment is not limited to that depicted in FIG. 18, but the visual confirmation decision system 1 may be configured otherwise such that the information processing device 5 acquires road sign information from the server 10 through the communication network 11 as described hereinabove in connection with the second embodiment.

Further, the visual confirmation decision system 1 of the present embodiment may be configured such that it includes the object detection sensor 12 described hereinabove in connection with the fourth embodiment.

Furthermore, the visual confirmation decision system 1 of the present embodiment may be configured such that the visual confirmation completion time period Dt is calculated taking also the gazing time period information 507c described hereinabove in connection with the third embodiment into consideration.

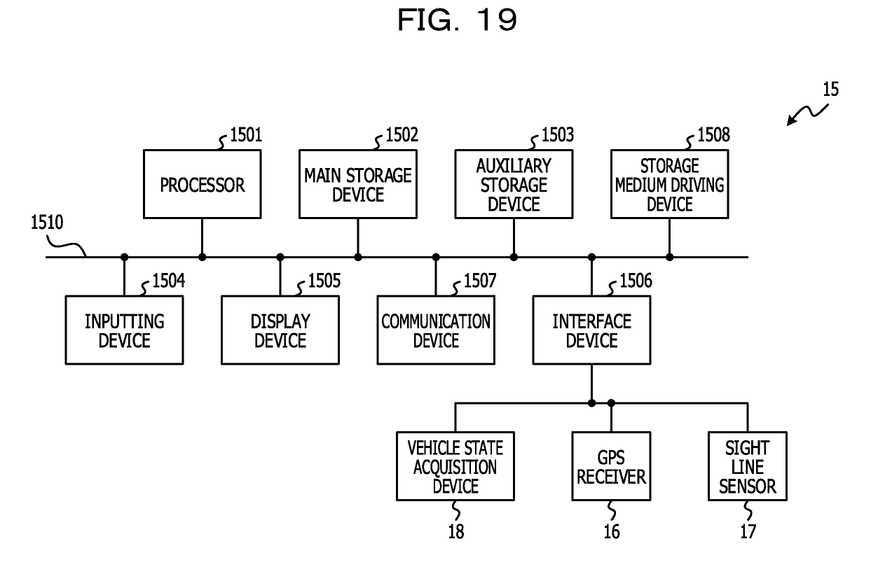

The information processing device 5 in the visual confirmation decision systems 1 according to the first to sixth embodiments can be implemented using, for example, a computer and a program for being executed by the computer. In the following, the information processing device 5 implemented using a computer and a program is described with reference to FIG. 19.

FIG. 19 is a block diagram depicting a hardware configuration of a computer. As depicted in FIG. 19, the computer 15 includes a processor 1501, main storage device 1502, an auxiliary storage device 1503, an inputting device 1504, a display device 1505, an interface device 1506, a communication device 1507, and a storage medium driving device 1508. The components 1501 to 1508 of the computer 15 are coupled to each other by a bus 1510 such that data can be passed between the components.

The processor 1501 is an arithmetic processing unit such as a central processing unit (CPU) and controls general operation of the computer 15 by executing various programs including an operating system.

The main storage device 1502 includes a read only memory (ROM) and a random access memory (RAM) not depicted. In the ROM of the main storage device 1502, a given basic control program that is read by the processor 1501, for example, upon activation of the computer 15 and other programs are stored in advance. Further, the RAM of the main storage device 1502 is used as occasion demands as a working storage area when the processor 1501 executes various programs. The RAM of the main storage device 1502 can be utilized for storage, for example, of the vehicle state information 507b, the gazing time period information 507c and information regarding a road sign detected by the sign searching unit 501 and so forth.

The auxiliary storage device 1503 is a storage device having a storage capacity greater than that of the main storage device 1502 such as a hard disk driver (HDD) or a solid state drive (SSD). Into the auxiliary storage device 1503, various programs to be executed by the processor 1501, various data and so forth can be stored. The auxiliary storage device 1503 can be utilized for programs and so forth including, for example, the processes of FIGS. 8 and 9A to 9C. Further, the auxiliary storage device 1503 can be utilized for storage, for example, of the road sign information 507a, message 507d, gazing time period information 507c, driver information 507e and so forth.

The inputting device 1504 is, for example, a keyboard unit or a touch panel unit. If an operator of the computer 15 performs such an operation as to depress the inputting device 1504, then the inputting device 1504 transmits input information associated with the substance of the operation to the processor 1501.

The display device 1505 is, for example, a liquid crystal display unit. The display device 1505 displays display images including various text screens, pictures and so forth in accordance with data of a display image transmitted thereto from the processor 1501 or the like.

The interface device 1506 is a device that couples the computer 15 and a different electronic device or the like to each other and includes a connector of the universal serial bus (USB) standard and so forth. As an electronic device that can be coupled to the computer 15 by the interface device 1506, a GPS receiver 16, a sight line sensor 17, a vehicle state acquisition device 18 and so forth are available.

The communication device 1507 is a device that performs various kinds of communication with an external device such as a different computer through the communication network 11 such as the Internet.

The storage medium driving device 1508 reads out a program or data recorded in a portable storage medium not depicted and performs writing of data and so forth stored in the auxiliary storage device 1503 into a portable storage medium. As the portable storage medium, for example, a flash memory that includes a connector of, for example, the USB standard is available. Further, as the portable storage medium, also an optical disk such as a compact disk (CD), a digital versatile disc (DVD) or a Blu-ray (registered trademark) disc is available.

In the computer 15, the processor 1501 reads out a program including the processes of FIGS. 8 and 9A to 9C from the auxiliary storage device 1503 or the like and performs calculation of the direction of a road sign and the direction of the sight line of a driver, calculation of a visual confirmation completion time period, a decision regarding whether or not a road sign is recognized by a driver and so forth.

It is to be noted that the computer 15 used as the information processing device 5 may not include all components depicted in FIG. 19 but can be configured omitting some component or components in accordance with an application or a condition.

Further, where the information processing device 5 is implemented from the computer 15 and a program, also it is possible, for example, to cause an automotive computer of a car navigation system or the like to execute a program including the processes of FIGS. 8 and 9A to 9C.

Further, where the information processing device 5 is implemented from the computer 15 and a program, also it is possible to transfer a history of the gazing time period information 507c to an external device through a portable recording medium or the communication network 11 such that visual confirmation decision results of a plurality of drivers 8 are managed by the external device. Where visual confirmation decision results of drivers 8 are managed by an external device in this manner, the visual confirmation decision results can be utilized for safe drive evaluation or drive guidance for a driver 8.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A system, comprising:
a receiver configured to receive vehicle information related to a position and orientation of a vehicle during travelling;
a light source configured to irradiate light of a specific wavelength on a driver of the vehicle;
an image sensor configured to pick up images of the driver on which light is irradiated by the light source; and
an information processing device including a processor configured to:
acquire sign information related to a road sign in an advancing direction of the vehicle based on the position and orientation of the vehicle acquired based on the vehicle information,
determine an estimated time period needed to recognize a substance of the road sign based on the vehicle information and a complexity of the road sign determined based on the sign information,
determine a gazing time period during which the driver gazes at the road sign based on the images picked up by the image sensor, and
output a warning based on a comparison between the estimated time period and the gazing time period.

2. The system according to claim 1, wherein
the sign information includes at least one of a number of characters included in the road sign, a number of words in the road sign, an average number of strokes in the road sign, and a graphic shape or the number of branches of a route indicated on the road sign, and
the complexity of the road sign is determined based upon at least one of the number of characters, the number of words, the average number strokes, and the graphic shape or the number of branches.

3. The system according to claim 1, wherein
the processor is further configured to determine the complexity of the road sign by calculating a visual confirmation degree relating to ease of grasping of the substance of the road sign on the basis of at least one of a number of characters of the road sign, a number of words of the road sign, an average number of strokes of the road sign, and a graphic shape or a number of branches of the road sign, and
the visual confirmation degree decreases as the substance of the road sign is less easy to grasp.

4. The system according to claim 3, wherein
the processor is further configured to determine the estimated time period by calculating a target time period based on the complexity of the road sign, and
the target time period is a target value of a period of time taken for the driver to grasp the substance of the road sign, increases as the complexity of the road sign increases and as the visual confirmation degree decreases.

5. The system according to claim 1, further comprising:
an acquisition device configured to acquire a vehicle state including a speed of the vehicle.

6. The system according to claim 5, wherein the estimated time period is determined further based on the speed of the vehicle.

7. The system according to claim 6, wherein
the estimated time period is determined further based on a distance between the position of the vehicle and an installation position of the road sign, and
the installation position is determined based on the sign information.

8. The system according to claim 1, wherein the processor is further configured to determine the gazing time period by
specifying a sight line direction of the driver at each of image pickup time points based on the images, and
determining the gazing time period as a time period starting from a first time point at which a state in which a difference between the sight line direction and a placement direction of the road sign as viewed by the driver is equal to or smaller than a first threshold value and ending at a second time point at which the state ends.

9. The system according to claim 8, wherein the processor is configured to output the warning by
comparing the estimated time period and the gazing time period, and
outputting a first warning to the driver when the comparison between the estimated time period and the gazing time period determines that gazing time period is shorter than the estimated time period.

10. The system according to claim 8, wherein the processor is configured to output the warning by
outputting a second warning to the driver, different from the first warning, when, while the state continues, an elapsed time period from the first time point at which the state starts exceeds the estimated time period and a difference between the elapsed time period and the estimated time period is equal to or longer than a second threshold value.

11. The system according to claim 10, wherein the second warning is a warning for instructing the driver to gaze in a direction other than that in which the road sign exists.

12. The system according to claim 8, wherein the processor is configured to acquire the information related to a road sign by
acquiring the vehicle information related to the position and orientation of the vehicle from the receiver,
searching, in response to an acquisition of the vehicle information, for the sign information of the road sign placed in a fixed range with respect to the position of the vehicle and the advancing direction from a plurality of pieces of sign information, and
acquiring the sign information.

13. The system according to claim 12, wherein the processor is further configured to output a third warning to the driver when the state is not established within a given time period from a third time point at which the information related to the road sign is acquired.

14. The system according to claim 13, wherein the third warning is a warning for announcing the presence of the road sign to the driver.

15. The system according to claim 12, wherein the sign information is acquired from a server that manages the plurality of pieces of sign information.

16. The system according to claim 1, wherein the estimated time period is corrected in response to a visual confirmation tendency of the road sign by the driver.

17. A method executed by a processor, the method comprising:
acquiring sign information related to a road sign in an advancing direction of a vehicle based on position and orientation of the vehicle;
determining an estimated time period needed for a driver of the vehicle to recognize a substance of the road sign based on the position and orientation of the vehicle, and a complexity of the road sign determined based on the sign information;
determining a gazing time period during which the driver gazes at the road sign based on images picked up by an image sensor; and
outputting a warning based on a comparison between the estimated time period and the gazing time period.

18. A non-transitory computer readable medium storing a computer-executable program causing a computer to execute a process, the process comprising:
acquiring sign information related to a road sign in an advancing direction of a vehicle based on position and orientation of the vehicle;
determining an estimated time period needed for a driver of the vehicle to recognize a substance of the road sign based on the position and orientation of the vehicle, and a complexity of the road sign determined based on the sign information;
determining a gazing time period during which the driver gazes at the road sign based on images picked up by an image sensor; and
outputting a warning based on a comparison between the estimated time period and the gazing time period.
